(19) United States
(12) Patent Application Publication
(10) Pub. No.: US 2025/0203707 A1
(43) Pub. Date: Jun. 19, 2025

(54) USER EQUIPMENT, BASE STATION, AND METHOD FOR EXTENDED REALITY (XR) SERVICES

(71) Applicant: SHARP KABUSHIKI KAISHA, Sakai City, Osaka (JP)

(72) Inventors: HSIN-HSI TSAI, Taipei (TW); HENG-LI CHIN, Taipei (TW)

(21) Appl. No.: 18/844,921

(22) PCT Filed: Mar. 8, 2023
(86) PCT No.: PCT/CN2023/080189

§ 371 Date: Sep. 6, 2024

Related U.S. Application Data
(60) Provisional application No. 63/318,311, filed on Mar. 9, 2022.

(51) Int. Cl. H04W 76/28

(52) U.S. Cl. CPC H04W 76/28

(57) ABSTRACT

A method performed by a UE for a DRX operation is provided. The method receives an RRC message for configuring a set of DRX configurations including at least a first DRX configuration that indicates first parameters for an integer DRX cycle. The method determines whether the set of DRX configurations includes a second DRX configuration indicating second parameters for a non-integer DRX cycle. The method determines whether to apply the first parameters or the second parameters based on whether the set of DRX configurations includes the second DRX configuration. The method starts, based on the first parameters, a DRX timer in a case that the set of DRX configurations does not include the second DRX configuration, and starts, based on the second parameters, the DRX timer in a case that the set of DRX configurations includes the second DRX configuration.

### CROSS-REFERENCE TO RELATED APPLICATION(S)

The present disclosure is a National Stage Application of International Patent Application Serial No. PCT/CN2023/080189, filed on Mar. 8, 2023, which claims the benefit of and priority to U.S. Provisional Patent Application Ser. No. 63/318,311, filed on Mar. 9, 2022, the contents of all which are hereby incorporated herein fully by reference into the present disclosure for all purposes.

### FIELD

The present disclosure is related to wireless communication and, more specifically, to eXtended Reality (XR) services in a wireless communication system.

### BACKGROUND

Various efforts have been made to improve different aspects of wireless communication for cellular wireless communication systems, such as the fifth-generation (5G) New Radio (NR) system, by improving data rate, latency, reliability, and mobility in these systems. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there exists a need for further improvements in the art, such as improvements in extended Reality (XR) services in wireless communications.

### SUMMARY

The present disclosure is related to communication between a User Equipment (UE) and a Base Station (BS), and their associated methods, for extended Reality (XR) services in a wireless communication system.

In a first aspect of the present disclosure, a method performed by a User Equipment (UE) for a discontinuous reception (DRX) operation is provided. The method includes receiving, from a Base Station (BS), a radio resource control (RRC) message for configuring one or more DRX configurations including at least a first DRX configuration that indicates parameters for an integer DRX cycle; determining whether the one or more DRX configurations include a second DRX configuration that indicates parameters for a non-integer DRX cycle; determining whether to apply the parameters for the integer DRX cycle or the parameters for the non-integer DRX cycle based on whether the one or more DRX configurations include the second DRX configuration or not; starting, based on the parameters for the integer DRX cycle, a DRX timer in a case that the one or more DRX configurations do not include the second DRX configuration; and starting, based on the parameters for the non-integer DRX cycle, the DRX timer in a case that the one or more DRX configurations include the second DRX configuration.

In an implementation of the first aspect, the parameters for the non-integer DRX cycle are associated with a frame per second (FPS) of data traffic that is received by the UE, and the parameters for the non-integer DRX cycle are indicated by decimal forms or fractional forms.

In an implementation of the first aspect, the second DRX configuration is configured for a DRX group.

In an implementation of the first aspect, the one or more DRX configurations include a third DRX configuration, and the third DRX configuration indicates parameters for a second non-integer DRX cycle.

In a second aspect of the present disclosure, a User Equipment (UE) for a discontinuous reception (DRX) operation is provided. The UE includes at least one processor; and at least one non-transitory computer-readable medium coupled to the at least one processor, and storing one or more computer-executable instructions that, when executed by the at least one processor, cause the UE to receive, from a Base Station (BS), a radio resource control (RRC) message for configuring one or more DRX configurations including at least a first DRX configuration that indicates parameters for an integer DRX cycle; determine whether the one or more DRX configurations include a second DRX configuration that indicates parameters for a non-integer DRX cycle; determine whether to apply the parameters for the integer DRX cycle or the parameters for the non-integer DRX cycle based on whether the one or more DRX configurations include the second DRX configuration or not; start, based on the parameters for the integer DRX cycle, a DRX timer in a case that the one or more DRX configurations do not include the second DRX configuration; and start, based on the parameters for the non-integer DRX cycle, the DRX timer in a case that the one or more DRX configurations include the second DRX configuration.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a DRX mechanism, according to an example implementation of the present disclosure.

FIG. 2 is a diagram illustrating a DCP mechanism with a wake-up indication, according to an example implementation of the present disclosure.

FIG. 3 is a diagram illustrating a mismatch between the XR traffic and the DRX cycle, according to an example implementation of the present disclosure.

FIG. 4 is a flowchart illustrating a method/process performed by a UE for an XR service, according to an example implementation of the present disclosure.

FIG. 5 is a flowchart illustrating a method/process performed by a BS for an XR service, according to an example implementation of the present disclosure.

FIG. 6 is a block diagram illustrating a node for wireless communication, according to an example implementation of the present disclosure.

### DETAILED DESCRIPTION

Some abbreviations used in this disclosure may include the following:

| Abbreviation | Full name |
|---|---|
| 3GPP | 3rd Generation Partnership Project |
| ACK | Acknowledgement |
| AI-RNTI | Availability Indication-Radio Network Temporary Identifier |
| AR | Augmented Reality |
| BS | Base Station |
| BSR | Buffer Status Reporting |
| BWP | Bandwidth Part |
| CG | Cloud Gaming/Cell Group |
| C-RNTI | Cell-Radio Network Temporary Identifier |
| CRC | Cyclic Redundancy Check |
| C-RNTI | Cell-Radio Network Temporary Identifier |
| CI-RNTI | Cancellation Indication-Radio Network Temporary Identifier |
| CS-RNTI | Configured Scheduling-Radio Network Temporary Identifier |
| CN | Core Network |
| CP | Cyclic Prefix |
| CSI | Channel State Information |
| DCI | Downlink Control Information |
| DCP | DCI with CRC scrambled by PS-RNTI |
| DL | Downlink |
| DRB | Dedicated Radio Bearer |
| DRX | Discontinuous Reception |
| eNB | Evolved Node B |
| fps | Frame Per Second |
| FR | Frequency Range |
| gNB | Next Generation Node B |
| GSM | Global System for Mobile communication |
| HARQ | Hybrid Automatic Repeat Request |
| ID | Identifier/Identity |
| IE | Information Element |
| INT-RNTI | Interruption-Radio Network Temporary Identifier |
| LCH | Logical Channel |
| MAC | Medium Access Control |
| MCG | Master Cell Group |
| MN | Master Node |
| MR | Mixed Reality |
| MSG | Message |
| NR | New Radio |
| NW | Network |
| OFDM | Orthogonal Frequency Division Multiplexing |
| PBCH | Physical Broadcast Channel |
| PCell | Primary Cell |
| PDB | Packet Delay Budget |
| PDCCH | Physical Downlink Control Channel |
| PDCP | Packet Data Convergence Protocol |
| PDSCH | Physical Downlink Shared Channel |
| PS-RNTI | Power Saving-Radio Network Temporary Identifier |
| PHY | Physical Layer |
| PSCell | Primary Secondary Cell |
| PUCCH | Physical Uplink Control Channel |
| PUSCH | Physical Uplink Shared Channel |
| RA | Random Access |
| RAR | Random Access Response |
| RAN | Radio Access Network |
| Rel | Release |
| RF | Radio Frequency |
| RLC | Radio Link Control |
| RRC | Radio Resource Control |
| RSRP | Reference Signal Received Power |
| RTT | Round Trip Time |
| RX | Reception |
| SA | System Aspects |
| SCell | Secondary Cell |
| SCG | Secondary Cell Group |
| SDAP | Service Data Adaptation Protocol |
| SFN | System Frame Number |
| SFI-RNTI | Slot Format Indicator-Radio Network Temporary Identifier |
| SL | Sidelink |
| SN | Secondary Node |
| SpCell | Special Cell |
| SP-CSI-RNTI | Semi-Persistent CSI-Radio Network Temporary Identifier |
| SR | Scheduling Request |
| SRB | Signaling Radio Bearer |
| SPS | Semi-Persistent Scheduling |
| SS | Search Space |
| TC-RNTI | Temporary Cell-Radio Network Temporary Identifier |
| TPC-PUCCH-RNTI | Transmit Power Control-PUCCH-Radio Network Temporary |
| | Identifier |
| TPC-PUSCH-RNTI | Transmit Power Control-PUSCH-Radio Network Temporary |
| | Identifier |
| TPC-SRS-RNTI | Transmit Power Control-Sounding Reference Symbols- |
| | Radio Network Temporary Identifier |
| TR | Technical Report |
| TRP | Transmission and Reception Point |
| TS | Technical Specification |
| Tx | Transmission |
| UE | User Equipment |
| UL | Uplink |
| UMTS | Universal Mobile Telecommunications System |
| URLLC | Ultra-Reliable and Low Latency Communication |
| VR | Virtual Reality |
| XR | eXtended Reality |
| XR-RNTI | eXtended Reality-Radio Network Temporary Identifier |

The following contains specific information related to implementations of the present disclosure. The drawings and their accompanying detailed disclosure are merely directed to implementations. However, the present disclosure is not limited to these implementations. Other variations and implementations of the present disclosure will be recognized by those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the so-disclosed combination, group, series, or equivalent. The expression “at least one of A, B and C”, “at least one of A, B or C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may include computer-executable instructions stored on computer-readable media, such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations in the present disclosure are directed to software installed and executing on computer hardware, alternative example implementations implemented as firmware, as hardware, or as a combination of hardware and software are well within the scope of the present disclosure.

The computer-readable medium includes, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long-Term Evolution (LTE) system, an LTE-Advanced (LTE-A) system, or an LTE-Advanced Pro system) typically includes at least one BS, at least one UE, and one or more optional NW elements that provide connection towards an NW. The UE communicates with the NW (e.g., a CN, an Evolved Packet Core (EPC) NW, an Evolved Universal Terrestrial Radio Access NW (E-UTRAN), a Next-Generation Core (NGC), a 5G Core (5GC) Network or an Internet) through a RAN established by the BS/Cell.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but is not limited to, a Node B (NB) as in the Universal Mobile Telecommunication System (UMTS), an eNB as in the LTE-A, a Radio NW Controller (RNC) as in the UMTS, a Base Station Controller (BSC) as in the Global System for Mobile communications (GSM)/GSM EDGE (Enhanced Data rates for GSM Evolution) Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), LTE-A Pro, and a next generation RAT. However, the scope of the present disclosure should not be limited to the protocols previously disclosed.

A BS may be operable to provide radio coverage to a specific geographical area using multiple cells included in the RAN. The BS may support the operations of the cells. Each cell is operable to provide services to at least one UE within its radio coverage. More specifically, each cell (often referred to as a serving cell) may provide services to serve one or more UEs within its radio coverage (e.g., each cell schedules the DL and optionally UL resources to at least one UE within its radio coverage for DL and optionally UL packet transmissions). The BS may communicate with one or more UEs in the radio communication system via the multiple cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or an SCG may be referred to as a SpCell. A PCell may be referred to as the SpCell of an MCG. A PSCell may be referred to as the SpCell of an SCG. The MCG may be referred as to a group of serving cells associated with an MN, including the SpCell and optionally one or more SCells. An SCG may be referred to as a group of serving cells associated with a Secondary Node (SN), including the SpCell and optionally one or more SCells.

In some implementations, the UE may not have (LTE/NR) RRC connections with the concerned serving cells of the associated services. In other words, the UE may not have UE-specific RRC signal exchange with the serving cell. Instead, the UE may only monitor the DL synchronization signals (e.g., DL synchronization burst sets) and/or broadcast SI related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR may support flexible configurations for accommodating various next generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the CP, may also be used. Additionally, two coding schemes may be considered for NR: (1) low-density parity-check (LDPC) code and (2) polar code. The coding scheme adaptation may be configured based on the channel conditions and/or service applications.

It should also be noted that in a transmission time interval of a single NR frame, at least DL transmission data, a guard period, and UL transmission data may be included. The respective portions of the DL transmission data, the guard period, and the UL transmission data may also be configurable, for example, based on the NW dynamics of NR. In addition, the SL resources may also be provided in an NR frame to support ProSe services.

Any two or more than two of the following sentences, paragraphs, (sub)-bullets, points, actions, behaviors, terms, alternatives, aspects, examples, or claims described in the following invention(s) may be combined logically, reasonably, and properly to form a specific method.

Any sentence, paragraph, (sub)-bullet, point, action, behaviors, terms, alternatives, aspects, examples, or claims described in the following invention(s) may be implemented independently and separately to form a specific method.

Dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

### Terminology

Some terminologies are introduced in the following:

User Equipment (UE): The UE may be referred to as the PHY/MAC/RLC/PDCP/SDAP entity. The PHY/MAC/RLC/PDCP/SDAP entity may also be referred to as the UE.

Base Station (BS): The BS may include a network node, a TRP, a cell (e.g., a Special Cell, a PCell, a PSCell, and/or a SCell), an eNB, or a gNB.

Serving Cell: The serving cell may include a PCell, a PSCell, or an SCell. The serving cell may be an activated or a deactivated serving cell.

Special Cell (SpCell): For Dual Connectivity operation, the SpCell may be referred to as the PCell of the Master Cell Group (MCG) or the PSCell of the Secondary Cell Group (SCG) based on whether the MAC entity is associated with the MCG or the SCG. In some implementations, the SpCell may be referred to as the PCell. The Special Cell may support the PUCCH transmission and the contention-based Random Access, and may be always activated.

### XR Enhancements for NR

The RAN 1 Rel-17 Study Item “Study on XR Evaluations for NR” has shown that the extended Reality (XR) and the Cloud Gaming (CG) are within the use cases and services considered important for the NR in Rel-18 and beyond. In general, the XR and the CG may be wide terms referring to various types of augmented, virtual, and mixed environments, where human-to-machine and human-to-human communications are performed with the assistance of handheld and wearable end user devices (such as UEs).

In some implementations, the CG may include the group of use cases, where the overwhelming majority of computations related to gaming (e.g., single-player or multi-player) is offloaded from the UE to edge or remote server(s). The XR may be a broad-scope umbrella for multiple heterogeneous use cases and services, which are studied and outlined in SA1, SA2, and SA4, including, but are not limited to, the 3GPP TR 22.842 and TR 26.928. These XR use cases may be roughly divided into: (i) augmented reality (AR), (ii) virtual reality (VR), and (iii) mixed reality (MR).

While the XR and CG present a set of attractive use cases for future mobile systems, they also may impose a set of challenges for NR that need to be studied and potentially addressed.

Many of the XR and CG use cases may be characterized by the quasi-periodic traffic (e.g., with possible jitter) with high data rate in the DL (e.g., a video stream) combined with the frequent UL (e.g., a pose/control update) and/or the UL video streaming. Both the DL and UL traffic may also be characterized by a relatively strict packet delay budget (PDB). Hence, there is a need to study and potentially specify possible solutions to better support such challenging services (e.g., by better matching the non-integer periodicity of traffic, such as 60/90/120 frames per second, to the NR signaling).

Many of the end user XR and CG devices may be expected to be mobile and of small-scale, thus having limited battery power resources. Therefore, additional power enhancements may be needed to reduce the overall UE power consumption when running the XR and CG services and thus extending the effective UE battery lifetime. From the Rel 17 Study Item on “XR evaluations”, it is identified that the current DRX configurations do not fit well for (i) the non-integer XR traffic periodicity, (ii) variable XR data rate, and (iii) quasi-periodic XR periodicity, hence enhancements may be beneficial in this area.

The set of anticipated XR and CG services having a certain variety and characteristics of the data streams (e.g., a video) may change “on-the-fly”, while the services are running over the NR. Therefore, additional information on the running services from higher layers may be beneficial to facilitate informed choices of radio parameters. From the Rel 17 Study item on “XR evaluations”, it is clear that the XR application awareness by the UE and gNB may improve the user experience, improve the NR system capacity in supporting the XR services, and reduce the UE power consumption. It may be expected that SA Working Groups may lead the work on identifying necessary enhancements to improve the XR awareness, and that RAN will be aware of these enhanced parameters and may potentially tailor the radio processing of the XR traffic.

### Discontinuous Reception (DRX)

When the UE is in an RRC_CONNECTED state, the UE (e.g., a MAC entity of the UE) may be configured (e.g., by an RRC and/or by a BS) with a DRX functionality that controls a PDCCH monitoring activity of the UE (e.g., the MAC entity). If the DRX functionality is configured, for all the activated Serving Cells, the UE (e.g., the MAC entity) may monitor the PDCCH discontinuously followed by the configured DRX functionality/operation. The DRX functionality/operation may be characterized as follows:

on-duration: The on-duration may include a duration controlled by drx-onDurationTimer that the UE waits for, after waking up, to receive the PDCCHs. If the UE successfully decodes a PDCCH, the UE may stay awake and start the inactivity-timer.

DRX cycle: The DRX cycle may specify the periodic repetition of the on-duration followed by a possible period of inactivity (e.g., being configured by drx-LongCycleStartOffset, drx-ShortCycle, and/or drx-ShortCycle Timer).

DRX inactivity timer: The DRX inactivity timer may include a duration controlled by drx-InactivityTimer that the UE requires to decode a PDCCH, from the last successful decoding of a PDCCH. If no PDCCH is decoded successfully while the drx-InactivityTimer is running, the UE may go back to sleep. The UE may restart the inactivity timer following a single successful decoding of a PDCCH for a first transmission only (e.g. that is not for retransmission(s)).

DRX retransmission timer: The DRX retransmission timer may include a duration until a retransmission may be expected, which may be controlled by drx-RetransmissionTimerDL and drx-Retransmission Timer UL.

DRX HARQ RTT timer: The DRX HARQ RTT timer may include a minimum duration before a DL assignment for a HARQ retransmission (e.g., configured by drx-HARQ-RTT-TimerDL) or a minimum duration before a UL HARQ retransmission grant (e.g., configured by drx-HARQ-RTT-TimerUL).

DRX slot offset: The DRX slot offset may include a delay before starting the drx-onDurationTimer (e.g., configured by drx-SlotOffset)

Active Time: The Active Time may include a total duration that the UE may monitor the PDCCH. The active time may include the on-duration of the DRX cycle, the time UE is performing continuous reception while the inactivity timer has not expired, and the time when the UE is performing continuous reception while waiting for a retransmission opportunity. Specifically, when the DRX functionality/operation is configured, the Active Time for the serving cells may include the time while:
drx-onDurationTimer or drx-InactivityTimer configured is running; or
drx-RetransmissionTimerDL or drx-RetransmissionTimerUL is running on any serving cell; or
ra-ContentionResolutionTimer or msgB-Response Window is running; or
a Scheduling Request is sent on the PUCCH and is pending; or
a PDCCH indicating a new transmission addressed to a C-RNTI of the MAC entity has not been received after successful reception of a Random Access Response (RAR) for a Random Access (RA) Preamble is not selected by the MAC entity among the contention-based Random Access Preamble.

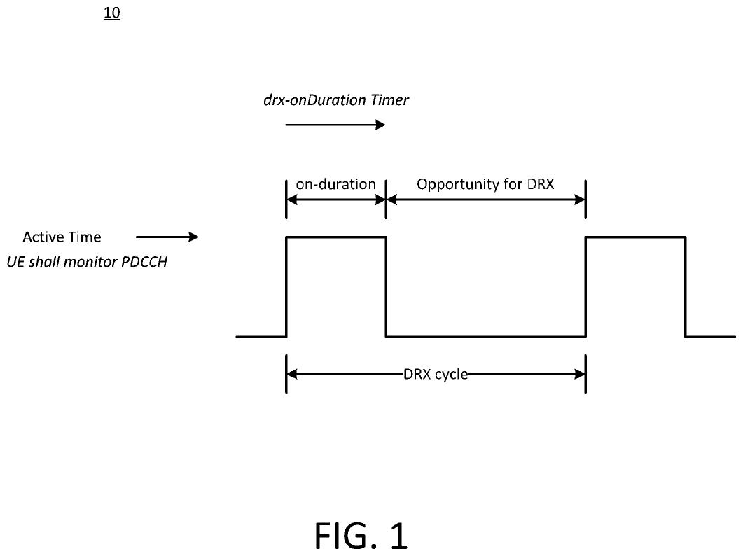

FIG. 1 is a diagram illustrating a DRX mechanism 10, according to an example implementation of the present disclosure. As shown in FIG. 1, it is illustrated that for each DRX cycle, the UE may start a drx-onDurationTimer at the beginning of the DRX cycle. The start timing of drx-onDurationTimer at the beginning of the DRX cycle may be followed by an offset (e.g., a drx-SlotOffset). The UE may start the drx-onDuration Timer after the drx-SlotOffset from the beginning of the subframe of the DRX cycle. While the drx-onDurationTimer is running, the UE is in the Active Time and may keep monitoring the PDCCH.

### Downlink Control Information (DCI)

In some implementations, the DCI may include a DCI format for scheduling of a PUSCH (e.g., format 0_0, format 0_1, format 0_2) and/or a PDSCH (e.g., format 1_0, 1_1, 1_2). In some implementations, the DCI may include a DCI format for other purpose (e.g., format 2_6). In some implementations, the DCI format 2_6 may be used for notifying the power saving information outside the DRX Active Time for one or more UEs. In some implementations, the DCI format 2_6 may be DCI scrambled by a PS-RNTI (e.g., the DCP). More details are indicated in the following table.

A UE configured with DRX mode operation, as specified in the 3GPP TS 38.321, may be
provided the following for detection of a DCI format 2_6 in a PDCCH reception on the PCell
or on the SpCell, as specified in the 3GPP TS 38.331:
a PS-RNTI for the DCI format 2_6 by ps-RNTI;
a number of search space sets, by dci-Format2-6, to monitor the PDCCH for detection of the
DCI format 2_6 on the active DL BWP of the PCell or of the SpCell according to a common
search space;
a payload size for the DCI format 2_6 by sizeDCI-2-6;
a location in the DCI format 2_6 of a Wake-up indication bit by ps-PositionDCI-2-6;
a ‘0’ value for the Wake-up indication bit, when reported to higher layers, indicates to not
start the drx-onDurationTimer for the next long DRX cycle;
a ‘1’ value for the Wake-up indication bit, when reported to higher layers, indicates to start
the drx-onDurationTimer for the next long DRX cycle;
a bitmap, when the UE is provided a number of groups of configured SCells by
dormancyGroupOutsideActiveTime, where
the bitmap location is immediately after the Wake-up indication bit location;
the bitmap size is equal to the number of groups of configured SCells, where each bit of the
bitmap corresponds to a group of configured SCells from the number of groups of configured
SCells;
a ‘0’ value for a bit of the bitmap indicates an active DL BWP, provided by dormantBWP-Id,
for the UE, as specified in the 3GPP TS 38.321, for each activated SCell in the corresponding
group of configured SCells;
a ‘1’ value for a bit of the bitmap indicates;
an active DL BWP, provided by firstOutsideActiveTimeBWP-Id, for the UE for each
activated SCell in the corresponding group of configured SCells, if a current active DL BWP
is the dormant DL BWP;
a current active DL BWP, for the UE for each activated SCell in the corresponding group of
configured SCells, if the current active DL BWP is not the dormant DL BWP;
the UE sets the active DL BWP to the indicated active DL BWP;
an offset by ps-Offset indicating a time, where the UE starts monitoring PDCCH for
detection of the DCI format 2_6 according to the number of search space sets, prior to a slot,
where the drx-onDurationTimer may start on the PCell or on the SpCell, as specified in the
3GPP TS 38.321; and
for each search space set, the PDCCH monitoring occasions are the ones in the first Tₛ slots
indicated by duration, or Tₛ = 1 slot if duration is not provided, starting from the first slot of
the first Tₛ slots and ending prior to the start of drx-onDurationTimer.
On PDCCH monitoring occasions associated with a same long DRX Cycle, a UE does
not expect to detect more than one DCI format 2_6 with different values of the Wake-up
indication bit for the UE or with different values of the bitmap for the UE. The UE does not
monitor PDCCH for detecting the DCI format 2_6 during Active Time, as specified in the
3GPP TS 38.321.

DCI with CRC Scrambled by PS-RNTI (DCP)

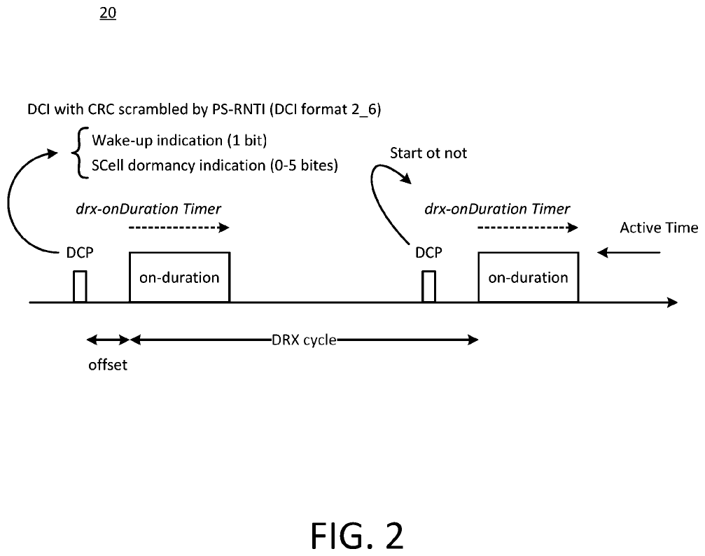

FIG. 2 is a diagram illustrating a DCP mechanism 20 with a wake-up indication, according to an example implementation of the present disclosure. As shown in FIG. 2, in some implementation, the UE may wake up to monitor the PDCCH for an on-duration at each DRX cycle. From UE's activity and data transmission viewpoint, the UE may not always need to be scheduled for each on-duration. As such, the UE may waste its power to monitor the PDCCH without receiving any scheduling. Since the PDCCH monitoring is a quite heavy power consumption behavior for the UE, the Rel 16 introduces new PHY signaling which may be used to further control the PDCCH monitoring behavior for the on-duration based on the configured DRX mechanism, which means the NW may send the new PHY signaling to the UE to instruct the UE to wake up within on-duration or not. The new PHY signaling may be referred to as the DCP.

In some implementations, the DCP may be indicated by the DCI format 2_6, which may be used for notifying the power saving information outside the DRX Active Time for one or more UEs. The DCI format 2_6 may include two indications: one is “Wake-up indication” (e.g., 1 bit), and the other is “SCell dormancy indication” (e.g., 0-5 bits). The “Wake-up indication” may be used to control the PDCCH monitoring behavior for the on-duration of the DRX.

Regarding DCP, the UE may be indicated by a “Wake-up indication”. When the UE is configured, the UE may determine whether it is required to monitor the PDCCH during the next occurrence of the on-duration, e.g., starting the drx-onDurationTimer, by the DCP monitored on the active BWP. More details are indicated in the following table:

UE may not start the drx-onDurationTimer for the next long DRX cycle when a value of
the Wake-up indication bit is ‘0’; and
UE starts the drx-onDurationTimer for the next long DRX cycle when a value of the
Wake-up indication bit is ‘1’.

In some implementations, if the UE detects a DCP on the active BWP, the 1 bit “Wake-up indication” may indicate whether the UE needs to monitor the PDCCH during the next occurrence of the on-duration or not. However, in some cases, the UE may fail to detect the DCP. For example, the UE may monitor the DCP, but unsuccessfully receives it (e.g., due to a bad channel quality). As such, if the UE does not detect a DCP on the active BWP, the UE may not monitor the PDCCH during the next occurrence of the on-duration (e.g., by default), unless the UE is explicitly configured to do so (e.g., by configuration). That is, the NW may instruct the UE to wake up or not if the DCP is not detected outside the active time (e.g., by the IE ps-Wakeup). More details are indicated in the following table:

```
If a UE is provided search space sets to monitor the PDCCH for detection of the DCI
format 2_6 in the active DL BWP of the PCell or of the SpCell and the UE does not detect
the DCI format 2_6:
  if the UE is provided ps-Wakeup, the UE may be indicated by ps-Wakeup whether
  the UE should (not) start the drx-onDurationTimer for the next DRX cycle; and
  if the UE is not provided ps-Wakeup, the UE may start Active Time for the next
  DRX cycle.
```

In some implementations, since the wake-up indication of the DCP is used to control the UE behavior for the drx-onDurationTimer, a UE may only be configured to monitor the DCP when a connected mode DRX (C-DRX) is configured, and at monitoring occasion(s) (e.g., PDCCH occasions) at a configured offset before the on-duration. The offset may be configured by the IE ps-Offset. Furthermore, more than one monitoring occasion for the DCP may be configured before the on-duration, e.g., a number of search space sets, by dci-Format2-6, to monitor the PDCCH for detection of the DCI format 2_6 on the active DL BWP (e.g., of the PCell or of the SpCell).

In some implementations, the monitoring occasion of the DCP may collide with other procedures or channels in time domain. Due to the limited UE capability, the UE may not perform all the defined behaviors simultaneously. Thus, the priority between the DCP monitoring and other procedures or channels may be specified, such that the UE may not need to monitor the DCP on occasions occurring during:
Active Time (e.g., of DRX),
Measurement gap, and
BWP switching.

In some implementations, when DCP monitoring occasion collides with other procedures with higher priority in the PDCCH monitoring, the DCP monitoring occasion may be considered as invalid. The UE may then follow the legacy behavior (e.g., following the legacy UE behaviors without the DCP mechanism).

In some implementations, if no DCP monitoring occasion (e.g., a search space) is configured in the active BWP, the UE may follow the normal DRX operation(s). The monitoring occasion for the DCP may be configured per BWP. However, the DCP configuration (e.g., DCP-Config) may be configured per cell group (e.g., MCG/SCG). The DCP configuration may include some parameters for the DCP functionality (e.g., PS-RNTI, offset for monitoring DCP, size of DCI 2_6, etc.).

In some implementations, one DCP may be configured to control the PDCCH monitoring during the on-duration for one or more UEs independently (e.g., based on ps-PositionDCI to indicate the starting position of the UE wakeup and SCell dormancy indication in the DCI format 2_6 for the UEs). The UE may be also configured (e.g., by an RRC and/or the BS) whether to report a periodic L1-RSRP (e.g., by the IE ps-TransmitPeriodicL1-RSRP) or a periodic CSI/L1-SINR (e.g., by the IE ps-TransmitPeriodicCSI) when the UE is not indicated to wake up (e.g., not starting a DRX on-duration timer) at the DRX on-duration.

### Mismatch Between XR Traffic and DRX Cycle

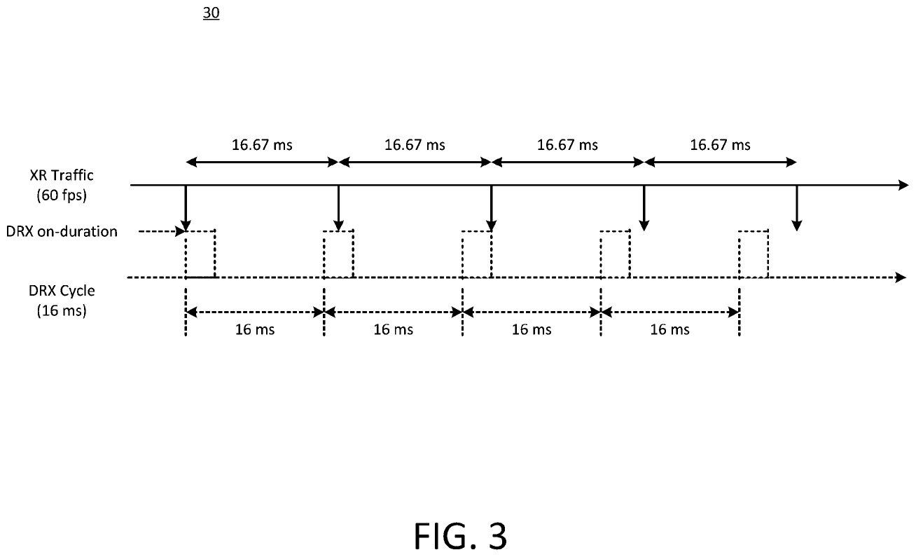

In some implementations, in the DRX mechanism, the DRX cycle may specify the periodic repetition of the on-duration followed by a possible period of the inactivity time. In some implementations, there may be two different types of DRX cycles. One is a long DRX cycle (e.g., configured by drx-LongCycleStartOffset) and the other is a short DRX cycle (e.g., configured by drx-ShortCycle). Until Rel-17, the values of the long DRX cycle may be configured to be 10, 20, 32, 40, 64, 70, 80, 128, 160, 256, 320, 512, 640, 1024, 1280, 2048, 2560, 5120, or 10240 millisecond (ms), and the values of the short DRX cycle may be configured to be 2, 3, 4, 5, 6, 7, 8, 10, 14, 16, 20, 30, 32, 35, 40, 64, 80, 128, 160, 256, 320, 512, or 640 ms. For XR application, 60 frame per second (fps) may be a baseline for both DL and UL video streams. 30 fps, 90 fps and 120 fps may also be optionally evaluated. Based on the formula of arrival time of the packet, corresponding periodicities may be {33.33 ms, 16.67 ms, 11.11 ms, 8.33 ms}. Based on the long DRX cycle and/or short DRX cycle configuration, the values of the DRX cycle may only be indicated as an integer that is multiples of 1 ms, which may not be aligned with the periodicities of the XR traffic (e.g., DL and/or UL frame arrival timing). As such, a mismatch between the XR data arrival interval and the DRX cycle may lead to a larger latency for data scheduling and may further reduce the XR capacity and/or lead to larger UE power consumption for keeping the same latency performance (e.g., extending the DRX on-duration). FIG. 3 is a diagram illustrating a mismatch 30 between the XR traffic and the DRX cycle, according to an example implementation of the present disclosure. As shown in FIG. 3, the DRX cycle is configured with 16 ms and the XR Traffic is 60 fps (e.g., the periodicity is 16.67 ms). The following mechanisms are proposed to solve the mismatch problem between the XR traffic and the DRX periodicity.

### Non-Integer DRX Cycle

### Methods to Derive the Non-Integer DRX Cycle

In some implementations, a specific DRX configuration may indicate a specific DRX cycle. Specifically, the specific DRX cycle may be a non-integer DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3, 50/3, 25/3, etc.).

Specifically, the DRX cycle may be a specific DRX cycle (e.g., a short DRX cycle, a long DRX cycle, a non-integer DRX cycle, and/or an XR DRX cycle).

In some implementations, the specific DRX configuration may indicate a value for deriving the specific DRX cycle. Specifically, the value for deriving the specific DRX may be an integer/denominator/fraction/decimal. Specifically, the value may be associated with the periodicity of the XR traffic and/or the fps of the XR application.

Specifically, the value may be used to derive a specific DRX cycle. In some implementations, the UE may use a DRX cycle (e.g., the short DRX cycle or the long DRX cycle) and the value to derive a specific DRX cycle (e.g., a non-integer DRX cycle and/or a specific DRX cycle for XR). In some implementations, the UE may determine a specific DRX cycle (e.g., a non-integer DRX cycle and/or a specific DRX cycle for XR) that is a DRX cycle (e.g., the short DRX cycle or the long DRX cycle) divided by the value.

In some implementations, the value for deriving the specific DRX may (only) be configured when a DRX cycle (e.g., short DRX cycle, long DRX cycle) is configured.

### Round the Value for Deriving the Specific DRX Cycle

In some implementations, if the UE derives the specific DRX cycle, based on the value, which is not an integer, the UE may round up the specific DRX cycle to an integer (e.g., a nearest value of the specific DRX cycle).

In some implementations, if the UE derives the specific DRX cycle, based on the value, which is not an integer, the UE may round the specific DRX cycle to an integer (e.g., a nearest value of the specific DRX cycle).

In some implementations, if the UE derives the specific DRX cycle, based on the value, which is not an integer, the UE may round down the specific DRX cycle to an integer (e.g., a nearest value of the specific DRX cycle).

In some implementations, if the UE derives the specific DRX cycle, based on the value, which is not an integer, the UE may round off the specific DRX cycle to an integer (e.g., a nearest value of the specific DRX cycle).

### Details of the Specific DRX Configuration

In some implementations, the specific DRX configuration may be an XR DRX configuration.

In some implementations, the specific DRX configuration may be different from the DRX-config (e.g., which is included in the MAC-CellGroupConfig).

In some implementations, the specific DRX configuration may be different from the drx-LongCycleStartOffset and/or the drx-ShortCycle.

In some implementations, the specific DRX configuration may further indicate one or more specific DRX cycles for XR.

In some implementations, the specific DRX configuration may further indicate a DRX start offset (e.g., for the specific DRX cycle).

In some implementations, the specific DRX configuration may further indicate a DRX on-duration timer (e.g., for the specific DRX cycle).

In some implementations, the specific DRX configuration may further indicate a DRX inactivity timer (e.g., for the specific DRX cycle).

In some implementations, the specific DRX configuration which indicates one or more non-integer values for the DRX cycle may be configured via an IE, such as DRX-ConfigNonIntegerCycles.

In some implementations, the specific DRX configuration may be configured/indicated by system information, an RRC configuration, a MAC CE, and/or DCI.

In some implementations, a unit of the specific DRX configuration, a value for deriving the specific DRX cycle, and/or the specific DRX cycle may be ms, slot-based, symbol-based, subframe-based, system frame-based, and/or second.

### Determination Between Specific DRX Configuration and Legacy DRX Configuration

In some implementations, if the UE is an XR-specific UE (e.g., the UE has an XR capability), the UE may apply the specific DRX configuration which indicates a specific DRX cycle and/or the value to determine a specific DRX cycle (e.g. the non-integer DRX cycle). Alternatively, the UE may apply the legacy DRX configuration (e.g., based on the DRX-config) and/or to determine the DRX cycle based on the legacy short DRX cycle/long DRX cycle (e.g., based on the drx-LongCycleStartOffset and/or the drx-ShortCycle).

In some implementations, if the UE transmits specific information to the BS, the UE may apply the specific DRX configuration which indicates a specific DRX cycle and/or the value to determine a specific DRX cycle (e.g. the non-integer DRX cycle). Alternatively, the UE may apply the legacy DRX configuration (e.g., based on the DRX-config) and/or to determine the DRX cycle based on the legacy short DRX cycle/long DRX cycle (e.g., based on the drx-LongCycleStartOffset and/or the drx-ShortCycle).

In some implementations, the specific information may be transmitted via an assistance information/UEAssistanceInformation IE (e.g., the assistance information for XR, for the non-integer DRX cycle, and/or for the DRX preference).

In some implementations, the specific information may be transmitted via a UE capability information/UECapabilityInformation IE (e.g., the UE capability information for XR, for the non-integer DRX cycle, and/or for the DRX preference).

In some implementations, the specific information may indicate that information for the XR traffic pattern/XR application/frame per second/periodicity for the DRX/pose control information.

In some implementations, the specific information may indicate that the UE prefers the non-integer DRX cycle.

In some implementations, the specific information may be transmitted via an RRC message, a MAC CE (e.g., an SR, a BSR, and/or an XR MAC CE), and/or PHY signaling (e.g., on a PUCCH).

In some implementations, if the UE is performing a procedure for the XR, the UE may apply the specific DRX configuration which indicates a specific DRX cycle and/or the value to determine a specific DRX cycle (e.g. the non-integer DRX cycle). Alternatively, the UE may apply the legacy DRX configuration (e.g., based on the DRX-config) and/or to determine the DRX cycle based on the legacy short DRX cycle/long DRX cycle (e.g., based on the drx-LongCycleStartOffset and/or the drx-ShortCycle).

In some implementations, the UE may enter/initiate/perform a procedure for the XR when data arrives at a specific LCH/SRB/DRB for the XR services and/or when the UE has pended the data from the specific LCH/SRB/DRB for the XR services. The specific LCH/SRB/DRB configuration for the XR services may be configured by the NW for conveying the XR data.

In some implementations, the UE may enter/initiate/perform a procedure for the XR when the UE triggers/initiates a BSR/SR/RA from a specific LCH/SRB/DRB for the XR services.

In some implementations, the UE may enter/initiate/perform a procedure for the XR when the UE receives scheduling information that schedules a UL/DL resource for transmitting the UL/DL XR traffics. Alternatively, the UE may enter/initiate/perform a procedure for the XR when the UE (successfully/unsuccessfully) receives the XR traffics on a DL resource (e.g., a PDSCH) and/or transmits the XR traffics on a UL resource (e.g., a PUSCH).

In some implementations, the UE may enter/initiate/perform a procedure for the XR when the UE receives a specific indication from the BS. The specific indication may indicate to the UE to enter/initiate/perform a procedure for the XR. The indication may be transmitted via an RRC message, a MAC CE (e.g., an XR MAC CE), and/or PHY signaling (e.g., on a PDCCH).

In some implementations, if the UE receive a specific indication from the BS, the UE may apply the specific DRX configuration which indicates a specific DRX cycle and/or the value to determine a specific DRX cycle (e.g. the non-integer DRX cycle). Alternatively, the UE may apply the legacy DRX configuration (e.g., based on the DRX-config) and/or to determine the DRX cycle based on the legacy short DRX cycle/long DRX cycle (e.g., based on the drx-LongCycleStartOffset and/or the drx-ShortCycle).

In some implementations, the specific indication may indicate to the UE to enter/initiate/perform a procedure for the XR.

In some implementations, the indication may be transmitted via an RRC message, a MAC CE (e.g., an XR MAC CE), and/or PHY signaling (e.g., on a PDCCH).

In some implementations, if the UE is configured with a specific configuration/IE, the UE may apply the specific DRX configuration which indicates a specific DRX cycle and/or the value to determine a specific DRX cycle (e.g. the non-integer DRX cycle). Alternatively, the UE may apply the legacy DRX configuration (e.g., based on the DRX-config) and/or to determine the DRX cycle based on the legacy short DRX cycle/long DRX cycle (e.g., based on the drx-LongCycleStartOffset and/or the drx-ShortCycle).

In some implementations, the specific configuration/IE may indicate scheduling information for the XR traffic.

In some implementations, the specific configuration/IE may trigger a procedure for the XR.

In some implementations, the specific configuration/IE may be a specific CG/SPS configuration for the XR services. The specific CG/SPS configuration for the XR services may be configured by the NW for transmitting the UL/DL XR data.

In some implementations, the specific configuration/IE may be a specific LCH/SRB/DRB for the XR services. The specific LCH/SRB/DRB configuration for the XR services may be configured by the NW for conveying the XR data.

### Granularity of Specific DRX Configuration

In some implementations, the specific DRX configuration which indicates a specific DRX cycle (with the non-integer value) and/or a value for deriving the specific DRX cycle may be included in another specific configuration/IE.

In some implementations, the specific DRX configuration which indicates a specific DRX cycle (e.g., with a non-integer value) and/or a value for deriving the specific DRX cycle may be configured per MAC entity (e.g., included in the MAC-CellGroupConfig). For example, the specific DRX configuration may be configured for a specific MAC entity.

In some implementations, the specific DRX configuration which indicates a specific DRX cycle (e.g., with a non-integer value) and/or a value for deriving the specific DRX cycle may be configured per DRX group (e.g., included in the secondaryDRX-GroupConfig and/or the DRX-ConfigSecondaryGroup and/or a DRX group for the XR). For example, the specific DRX configuration may be configured for a specific DRX group. Specifically, the DRX group may be specifically configured for the XR. The NW may configure the DRX group to be specifically for the XR via a specific configuration/IE.

In some implementations, the specific DRX configuration which indicates a specific DRX cycle (e.g., with a non-integer value) and/or a value for deriving the specific DRX cycle may be configured per DRX configuration (e.g., included in the DRX-Config and/or the DRX-Config2 and/or an XR DRX configuration). For example, the specific DRX configuration may be configured for a specific DRX configuration.

In some implementations, the specific DRX configuration which indicates a specific DRX cycle (e.g., with a non-integer value) and/or a value for deriving the specific DRX cycle may be configured per Cell Group (e.g., the MCG/SCG) (e.g., included in the CellGroupConfig). For example, the specific DRX configuration may be configured for a specific Cell Group (e.g., the MCG/SCG).

In some implementations, the specific DRX configuration which indicates a specific DRX cycle (e.g., with a non-integer value) and/or a value for deriving the specific DRX cycle may be configured per cell/serving cell (e.g., included in the SpCellConfig or the SCellConfig). For example, the specific DRX configuration may be configured for a specific cell/serving cell. Specifically, the cell/serving cell may be specifically configured for the XR. The NW may configure the cell/serving cell to be specifically for the XR via a specific configuration/IE.

In some implementations, the specific DRX configuration which indicates a specific DRX cycle (e.g., with a non-integer value) and/or a value for deriving the specific DRX cycle may be configured per BWP (e.g., included in a BWP configuration). For example, the specific DRX configuration may be configured for a specific BWP. Specifically, the BWP may be specifically configured for the XR. The NW may configure the BWP to be specifically for the XR via a specific configuration/IE.

In some implementations, the specific DRX configuration which indicates a specific DRX cycle (e.g., with a non-integer value) and/or a value for deriving the specific DRX cycle may be configured per set/group of cells. For example, the specific DRX configuration may be configured for a specific set/group of cells. Specifically, the UE may be configured with one or more sets/groups of cells. The set/group of cells may include one or more cells. The set/group of cells may include the SpCell and/or SCell(s). The UE may be indicated that each cell is related to which set/group of cells. The set/group of cells may correspond to a specific Frequency Range (FR) (e.g., FR1 and/or FR2). The set/group of cells may correspond to the dormancy SCell group(s). The set/group of cells may be specifically configured for the XR. The NW may configure the set/group of cells to be specifically for the XR via a specific configuration/IE.

In some implementations, the UE may apply the specific DRX configuration which indicates a specific DRX cycle (e.g., with a non-integer value) and/or the value for deriving the specific DRX cycle for a MAC entity/DRX group/DRX configuration/Cell Group (e.g., the MCG/SCG)/cell/serving cell/BWP/set of cells which is configured with the specific DRX configuration and/or the value for deriving the specific DRX cycle.

In some implementations, the UE may apply the legacy DRX configuration (e.g., configured by the DRX-Config) and/or the short/long DRX cycle (e.g., configured by the drx-LongCycleStartOffset and/or the drx-ShortCycle) for a MAC entity/DRX group/DRX configuration/Cell Group (e.g., the MCG/SCG)/cell/serving cell/BWP/set of cells which is not configured with the specific DRX configuration and/or is not configured with the value for deriving the specific DRX cycle.

In some implementations, the UE may apply the specific DRX configuration which indicates a specific DRX cycle (e.g., with a non-integer value) and/or the value for deriving the specific DRX cycle for a second MAC entity/DRX group/DRX configuration/Cell Group (e.g., the MCG/SCG)/cell/serving cell/BWP/set of cells based on the specific DRX configured for a first MAC entity/DRX group/DRX configuration/Cell Group (e.g., the MCG/SCG)/cell/serving cell/BWP/set of cells (e.g., in a case that the UE is not configured with the specific DRX configuration which indicates a specific DRX cycle (e.g. with a non-integer value) and/or the value for deriving the specific DRX cycle for the second MAC entity/DRX group/DRX configuration/Cell Group (e.g., the MCG/SCG)/cell/serving cell/BWP/set of cells).

In some implementations, the UE may receive a first specific DRX configuration which indicates a first specific DRX cycle (e.g., with a non-integer value) and/or the first value for deriving the specific DRX cycle for a first MAC entity/DRX group/DRX configuration/Cell Group (e.g., the MCG/SCG)/cell/serving cell/BWP/set of cells. In addition, the UE may receive a second specific DRX configuration which indicates a first specific DRX cycle (e.g., with non-integer value) and/or the first value for deriving the specific DRX cycle for a second MAC entity/DRX group/DRX configuration/Cell Group (e.g., the MCG/SCG)/cell/serving cell/BWP/set of cells.

In some implementations, the first specific DRX configuration may be configured with the same information as the second specific DRX configuration.

In some implementations, the first specific DRX cycle (e.g., with a non-integer value) and the second DRX cycle (e.g., with a non-integer value) may be configured with the same value.

In some implementations, the first value for deriving the specific DRX cycle and the second value for deriving the specific DRX cycle may be configured with the same value.

Specific DRX Cycle and/or Legacy DRX Cycle

In some implementations, the UE may not be expected to be configured with both types of DRX cycles, such as, a specific DRX cycle (e.g., a non-integer DRX cycle) and a legacy DRX cycle (e.g., the drx-LongCycleStartOffset and/or the drx-ShortCycle), at the same time.

In some implementations, if the UE is an XR-specific UE (e.g., the UE has the XR capability), the UE may be configured with the specific DRX cycle (e.g., a non-integer DRX cycle) and may not be configured with the legacy DRX cycle (e.g., the drx-LongCycleStartOffset and/or the drx-ShortCycle).

In some implementations, if the UE transmits a specific information to the BS, the UE may be configured with the specific DRX cycle (e.g., a non-integer DRX cycle) and may not be configured with the legacy DRX cycle (e.g., the drx-LongCycleStartOffset and/or the drx-ShortCycle). Specifically, the specific information may be transmitted via an assistance information/UEAssistanceInformation IE (e.g., the assistance information for the XR, for a non-integer DRX cycle, and/or for a DRX preference). The specific information may be transmitted via a UE capability information/UECapabilityInformation IE (e.g., the UE capability information for the XR, for a non-integer DRX cycle, and/or for a DRX preference). The specific information may indicate that information for the XR traffic pattern/XR application/frame per second/periodicity for the DRX/pose control information. The specific information may indicate that the UE prefers the non-integer DRX cycle. The specific information may be transmitted via a MAC CE (e.g., an SR, a BSR, and/or an XR MAC CE).

In some implementations, if the UE is performing a procedure for the XR, the UE may be configured with the specific DRX cycle (e.g., a non-integer DRX cycle) and may not be configured with the legacy DRX cycle (e.g., the drx-LongCycleStartOffset and/or the drx-ShortCycle).

In some implementations, if the UE is configured with a specific configuration/IE, received from the BS, the UE may be configured with the specific DRX cycle (e.g., a non-integer DRX cycle) and may not be configured with the legacy DRX cycle (e.g., the drx-LongCycleStartOffset and/or the drx-ShortCycle). Specifically, the specific configuration/IE may indicate scheduling information for the XR traffic. The specific configuration/IE may trigger an XR procedure.

In some implementations, the NW may configure the specific DRX cycle on the specific BWP/serving cell/set of serving cells. The NW may not configure the legacy DRX cycle on the specific BWP/serving cell/set of serving cells.

In some implementations, the UE may be configured with both types of DRX cycles, such as, the specific DRX cycle (e.g., a non-integer DRX cycle) and the legacy DRX cycle (e.g., the drx-LongCycleStartOffset and/or the drx-ShortCycle), at the same time.

In some implementations, the UE may ignore one of the two types of the specific DRX cycle (e.g., a non-integer DRX cycle) and the legacy DRX cycle (e.g., the drx-LongCycleStartOffset and/or the drx-ShortCycle).

In some implementations, if the UE is configured with the specific DRX cycle (e.g., a non-integer DRX cycle), the UE may ignore the legacy DRX cycle (e.g., the drx-LongCycleStartOffset and/or the drx-ShortCycle).

In some implementations, if the UE is an XR-specific UE, the UE may ignore one of the two types of the specific DRX cycle (e.g., a non-integer DRX cycle) and the legacy DRX cycle (e.g., the drx-LongCycleStartOffset and/or the drx-ShortCycle) and/or the UE may apply the specific DRX cycle.

In some implementations, if the UE transmits specific information to the BS, the UE may ignore one of the two types of the specific DRX cycle (e.g., a non-integer DRX cycle) and the legacy DRX cycle (e.g., the drx-LongCycleStartOffset and/or the drx-ShortCycle) and/or the UE may apply the specific DRX cycle. Specifically, the specific information may be transmitted via an assistance information/UEAssistanceInformation IE (e.g., the assistance information for the XR, for a non-integer DRX cycle, and/or for a DRX preference). The specific information may be transmitted via a UE capability information/UECapabilityInformation IE (e.g., the UE capability information for the XR, for a non-integer DRX cycle, and/or for a DRX preference). The specific information may indicate that information for the XR traffic pattern/XR application/frame per second/periodicity for the DRX/pose control information. The specific information may indicate that the UE prefers the non-integer DRX cycle. The specific information may be transmitted via a MAC CE (e.g., an SR, a BSR, and/or an XR MAC CE).

In some implementations, if the UE is performing a procedure for the XR, the UE may ignore one of the two types of the specific DRX cycle (e.g., a non-integer DRX cycle) and the legacy DRX cycle (e.g., the drx-LongCycleStartOffset and/or the drx-ShortCycle) and/or the UE may apply the specific DRX cycle.

In some implementations, if the UE is configured with a specific configuration/IE, from the BS, the UE may ignore one of the two types of the specific DRX cycle (e.g., a non-integer DRX cycle) and the legacy DRX cycle (e.g., the drx-LongCycleStartOffset and/or the drx-ShortCycle) and/or the UE may apply the specific DRX cycle. Specifically, the specific configuration/IE may indicate scheduling information for the XR traffic. The specific configuration/IE may trigger an XR procedure.

In some implementations, the UE may determine a field of one of the both types of the specific DRX cycle (e.g., a non-integer DRX cycle) and the legacy DRX cycle (e.g., the drx-LongCycleStartOffset and/or the drx-ShortCycle) as absent.

In some implementations, if the UE is configured with the specific DRX cycle (e.g., a non-integer DRX cycle), the UE may determine the field of the legacy DRX cycle (e.g., the drx-LongCycleStartOffset and/or the drx-ShortCycle) as absent.

In some implementations, if the UE is an XR-specific UE, the UE may determine the field of one of the two types of the specific DRX cycle (e.g., a non-integer DRX cycle) and the legacy DRX cycle (e.g., the drx-LongCycleStartOffset and/or the drx-ShortCycle) as absent.

In some implementations, if the UE transmits specific information to the BS, the UE may determine the field of one of the two types of the specific DRX cycle (e.g., a non-integer DRX cycle) and the legacy DRX cycle (e.g., the drx-LongCycleStartOffset and/or the drx-ShortCycle) as absent. Specifically, the specific information may be transmitted via an assistance information/UEAssistanceInformation IE (e.g., the assistance information for the XR, for a non-integer DRX cycle, and/or for a DRX preference). The specific information may be transmitted via a UE capability information/UECapabilityInformation IE (e.g., the UE capability information for the XR, for a non-integer DRX cycle, and/or for a DRX preference). The specific information may indicate that information for the XR traffic pattern/XR application/frame per second/periodicity for the DRX/pose control information. The specific information may indicate that the UE prefers the non-integer DRX cycle. The specific information may be transmitted via a MAC CE (e.g., an SR, a BSR, and/or an XR MAC CE).

In some implementations, if the UE is performing a procedure for the XR, the UE may determine the field of one of the two types of the specific DRX cycle (e.g., a non-integer DRX cycle) and the legacy DRX cycle (e.g., the drx-LongCycleStartOffset and/or the drx-ShortCycle) as absent.

In some implementations, if the UE is configured with a specific configuration/IE, from the BS, the UE may determine the field of one of the two types of the specific DRX cycle (e.g., a non-integer DRX cycle) and the legacy DRX cycle (e.g., the drx-LongCycleStartOffset and/or the drx-ShortCycle) as absent. Specifically, the specific configuration/IE may indicate scheduling information for the XR traffic. The specific configuration/IE may trigger an XR procedure.

### XR Short and Long DRX Cycles

In some implementations, the UE may be configured with one or more non-integer DRX cycles.

In some implementations, the UE may be configured with one single non-integer DRX cycle. In some implementations, the UE may determine the non-integer DRX cycle as a long DRX cycle. The UE may then perform the DRX operation for the long DRX cycle based on the non-integer DRX cycle. In some implementations, the UE may determine the non-integer DRX cycle as a short DRX cycle. The UE may then perform the DRX operation for the short DRX cycle based on the non-integer DRX cycle.

In some implementations, the UE may be configured with two non-integer DRX cycles. For example, a first non-integer DRX cycle may include a short non-integer DRX cycle, and a second non-integer DRX cycle may include a long non-integer DRX cycle. In some implementations, the UE may determine the short non-integer DRX cycle as a short DRX cycle. The UE may then perform the DRX operation for the short DRX cycle based on the short non-integer DRX cycle. In some implementations, the UE may determine the long non-integer DRX cycle as a long DRX cycle. The UE may then perform the DRX operation for the long DRX cycle based on the long non-integer DRX cycle.

### XR-Specific RNTI/Search Space/CORESET

In some implementations, the operation of the specific DRX configuration and the operation of the legacy DRX configuration may be independently performed for a UE's specific RNTI (e.g., the XR-RNTI, C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, etc.). As such, if one or both of the specific DRX configuration (e.g., including a non-integer DRX cycle and/or non-integer DRX timer values) and the legacy DRX configuration (e.g., including an integer DRX cycle and/or integer DRX timer values) are configured, the UE may monitor the PDCCH for the UE's specific RNTI based on the DRX Active Time derived from one or both of the specific DRX configuration and the legacy DRX configuration.

In some implementations, the specific DRX configuration may (only) be used to control the UE's PDCCH monitoring activity for a specific RNTI (e.g., the XR-RNTI) of the UE. Specifically, the specific RNTI may be mapped to one or more XR services. The specific RNTI may be configured via the specific DRX configuration and/or a configuration for the XR. The specific RNTI may be configured to the UE via RRC signaling. The specific RNTI may be associated with DCI to schedule the DL resource (e.g., a PDSCH) and/or the UL resource (e.g., a PUSCH) including the XR services. The specific RNTI may be associated with a DCI to preempt other UL/DL traffics.

In some implementations, the UE may monitor the PDCCH based on the specific RNTI (e.g., XR-RNTI) for the DRX Active Time derived from the specific DRX configuration. Specifically, the DRX Active Time derived from the specific DRX configuration may include that a DRX on-duration timer and/or a DRX inactivity timer (e.g., configured by the specific DRX configuration) is running.

In some implementations, the operation of the specific DRX configuration may be performed for the UE's first RNTI, first search space, and/or first CORESET and the operation of the legacy DRX configuration may be performed for the UE's second RNTI, second search space, and/or second CORESET.

In some implementations, the first RNTI may be one or more of the following RNTIs:
The XR-RNTI, the C-RNTI, the CI-RNTI, the CS-RNTI, the INT-RNTI, the SFI-RNTI, the SP-CSI-RNTI, the TPC-PUCCH-RNTI, the TPC-PUSCH-RNTI, the TPC-SRS-RNTI, and the AI-RNTI, etc.

In some implementations, the second RNTI may include one or more of the following:
The second RNTI may be mapped to one or more XR services;
The second RNTI may be configured via the specific DRX configuration and/or a configuration for the XR;
The second RNTI may be configured to the UE via RRC signaling;
The second RNTI may be associated with DCI to schedule a DL resource (e.g., a PDSCH) and/or a UL resource (e.g., a PUSCH) including the XR services; and
The second RNTI may be associated with a DCI to preempt other UL/DL traffics.

In some implementations, the UE may be configured with a configuration/IE to indicate whether the UE may perform the operation of the specific DRX configuration for the first RNTI and/or the second RNTI.

In some implementations, the UE may be configured with a configuration/IE to indicate whether the UE may perform the operation of the legacy DRX configuration for the first RNTI and/or the second RNTI.

In some implementations, the specific DRX configuration may (only) be used to control the UE's PDCCH monitoring activity for a specific search space/CORESET/PDCCH configuration of the UE. The specific search space/CORESET/PDCCH configuration may be configured specifically for monitoring a specific RNTI (e.g., the XR-RNTI) and/or a specific DCI format for scheduling the UL/DL XR traffics.

In some implementations, a specific search space/CORESET/PDCCH configuration with a non-integer duration may be configured at a UE. The specific CORESET/search space/PDCCH configuration may be configured specifically for monitoring a specific RNTI (e.g., the XR-RNTI) and/or a specific DCI format for scheduling the UL/DL XR traffics.

In some implementations, the specific CORESET/search space/PDCCH configuration may be configured via the specific DRX configuration and/or a configuration for the XR.

In some implementations, the UE may monitor the PDCCH based on the specific search space/CORESET/PDCCH configuration when a timer (e.g., of the specific DRX configuration) is running. Specifically, the timer may be a DRX on-duration timer and/or a DRX inactivity timer (e.g., configured by the specific DRX configuration) that is running.

In some implementations, when the specific DRX configuration that is used to control the UE's PDCCH monitoring activity for a specific search space/CORESET/PDCCH configuration of the UE is absent, the UE's monitoring activity of the specific a specific search space/CORESET/PDCCH configuration may be based on the legacy DRX configuration.

In some implementations, the operation of the specific DRX configuration may be performed for the UE's first RNTI/search space/CORESET and the operation of the legacy DRX configuration may be performed for the UE's second RNTI/search space/second CORESET.

In some implementations, the first RNTI may be one or more of the following RNTIs:
The XR-RNTI, the C-RNTI, the CI-RNTI, the CS-RNTI, the INT-RNTI, the SFI-RNTI, the SP-CSI-RNTI, the TPC-PUCCH-RNTI, the TPC-PUSCH-RNTI, the TPC-SRS-RNTI, and the AI-RNTI, etc.

In some implementations, the second RNTI/search space/CORESET may include one or more of the following:
The second RNTI/search space/CORESET may be a specific RNTI/search space/CORESET;
The second RNTI/search space/CORESET may be mapped to one or more XR services;
The second RNTI/search space/CORESET may be configured via the specific DRX configuration and/or a configuration for the XR;
The second RNTI/search space/CORESET may be configured to the UE via RRC signaling;
The second RNTI/search space/CORESET may be associated with DCI to schedule a DL resource (e.g., a PDSCH) and/or a UL resource (e.g., a PUSCH) including the XR services; and
The second RNTI may be associated with DCI to preempt other UL/DL traffics.

In some implementations, the UE may be configured with a configuration/IE to indicate (e.g., to enable/disable) whether the UE may perform the operation of the specific DRX configuration for the first RNTI/search space/CORESET and/or the second RNTI/search space/CORESET.

In some implementations, the UE may be configured with a configuration/IE to indicate (e.g., to enable/disable) whether the UE may perform the operation of the legacy DRX configuration for the first RNTI/search space/CORESET and/or the second RNTI/search space/CORESET.

### Switching of DRX Cycles

In some implementations, the UE may switch the DRX cycles (e.g., for a MAC entity/DRX group/DRX configuration/Cell Group (e.g., the MCG/SCG)/cell/serving cell/BWP/set of cells) based on one or more criteria (e.g., an indication, a configuration, an event, a timer, and/or a counter). The UE switching the DRX cycles may imply that the UE replaces a first DRX cycle with a second DRX cycle.

In some implementations, the UE may switch from a first DRX cycle to a second DRX cycle based on one or more criteria (e.g., an indication, a configuration, an event, a timer, and/or a counter).

In some implementations, after the UE switches to a second DRX cycle, the UE may switch back to a first DRX cycle based on one or more criteria (e.g., an indication, a configuration, an event, a timer, and/or a counter).

In some implementations, the first DRX cycle may be a short DRX cycle (e.g., with an integer value), a long DRX cycle (e.g., with an integer value), and/or a specific DRX cycle (e.g., with a non-integer value).

In some implementations, the second DRX cycle may be a short DRX cycle (e.g., with an integer value), a long DRX cycle (e.g., with an integer value), and/or a specific DRX cycle (e.g., with a non-integer value).

### Alternatives for Switching DRX Cycle

In some implementations, the UE may switch the DRX cycles (e.g., for a MAC entity/DRX group/DRX configuration/Cell Group (e.g., the MCG/SCG)/cell/serving cell/BWP/set of cells) based on an indication and/or a configuration received from a BS.

In some implementations, when the UE receives an indication and/or a configuration from a BS, the UE may switch a first DRX cycle to a second DRX cycle (e.g., for a MAC entity/DRX group/DRX configuration/Cell Group (e.g., the MCG/SCG)/cell/serving cell/BWP/set of cells).

In some implementations, the UE may determine whether to switch the DRX cycle (e.g., for a MAC entity/DRX group/DRX configuration/Cell Group (e.g., the MCG/SCG)/cell/serving cell/BWP/set of cells) based on an indication and/or a configuration.

In some implementations, the UE may determine to switch the first DRX cycle (e.g., for a MAC entity/DRX group/DRX configuration/Cell Group (e.g., the MCG/SCG)/cell/serving cell/BWP/set of cells) to the second DRX cycle based on the indication and/or a configuration.

In some implementations, the indication may be received via DCI, a MAC CE, and/or an RRC configuration. Specifically, the indication may indicate information of a MAC entity/DRX group/DRX configuration/Cell Group (e.g., the MCG/SCG)/cell/serving cell/BWP/set of cells. The indication may indicate the specific DRX cycle. The indication may indicate the value for deriving the specific DRX cycle. The indication may be a UL grant and/or a DL assignment that schedules the XR traffics. The indication may be DCI received on a PDCCH/search space/CORESET configured for the XR traffics. The indication may be a PDCCH/DCI addressed to a specific RNTI (e.g., the XR-RNTI). The indication may be a PDCCH/DCI monitored/received on a specific search space/CORESET (e.g., for the XR). The indication may be a PDCCH/DCI with a specific DCI format (e.g., for the XR). The indication may indicate a PDSCH including the XR traffics. In some implementations, the PUSCH may correspond to a specific SPS configured for the XR services.

In some implementations, the configuration may be received via DCI, a MAC CE, and/or an RRC configuration. Specifically, the configuration may indicate information of a MAC entity/DRX group/DRX configuration/Cell Group (e.g., the MCG/SCG)/cell/serving cell/BWP/set of cells. The indication may indicate the specific DRX cycle. The indication may indicate the value for deriving the specific DRX cycle.

In some implementations, the UE may switch the DRX cycles based on an event.

In some implementations, if the UE transmits specific information to the BS, the UE may switch the DRX cycles (e.g., for a MAC entity/DRX group/DRX configuration/Cell Group (e.g., the MCG/SCG)/cell/serving cell/BWP/set of cells). Specifically, the specific information may indicate that information for the XR traffic pattern/XR application/frame per second/periodicity for DRX/pose control information. The specific information may indicate a HARQ feedback (e.g., a HARQ ACK/NACK) (e.g., for DCI, a PDSCH transmission, and/or the indication for switching the DRX cycle). The specific information may indicate that the UE prefers the non-integer DRX cycle. The specific information may indicate a PUSCH including an XR traffic. In some implementations, the PUSCH may correspond to a CG configured specifically for the XR services.

In some implementations, if the UE switches a BWP not configured with a non-integer DRX cycle (e.g., a BWP configured with legacy DRX configuration only) to other BWP configured with a non-integer DRX cycle (e.g., a BWP configured with the specific DRX configuration), the UE may switch from an integer DRX cycle to a non-integer DRX cycle. In some implementations, if the UE switches a BWP configured with a non-integer DRX cycle (e.g., a BWP configured with the specific DRX configuration) to other BWP not configured with a non-integer DRX cycle (e.g., a BWP configured with the legacy DRX configuration only), the UE may switch from a non-integer DRX cycle to an integer DRX cycle. This may be under the assumption that the DRX configuration is configured per BWP.

In some implementations, if the UE deactivates a serving cell configured with a non-integer DRX cycle and/or the UE determines that it has no activated serving cell configured with a non-integer DRX cycle, the UE may switch from a non-integer DRX cycle to an integer DRX cycle. In some implementations, if the UE activates a serving cell configured with a non-integer DRX cycle and/or the UE determines that it has at least one activated serving cell configured with a non-integer DRX cycle, the UE may switch from an integer DRX cycle to a non-integer DRX cycle.

In some implementations, the UE may switch the DRX cycles based on a timer and/or a duration (e.g., configured by a BS).

In some implementations, when a timer expires, the UE may switch the DRX cycles (e.g., for a MAC entity/DRX group/DRX configuration/Cell Group (e.g., the MCG/SCG)/cell/serving cell/BWP/set of cells).

In some implementations, the timer may be a DRX timer, a specific DRX inactivity timer, a DRX on-duration timer, a DRX retransmission timer for a DL, a DRX retransmission timer for a UL, a DRX HARQ RTT timer for a DL, a DRX HARQ RTT timer for a UL, a DRX short cycle timer, an XR-specific DRX timer, etc.

In some implementations, the timer may be (re)started when the UE has switched the DRX cycle to a first DRX cycle and/or a second DRX cycle.

In some implementations, the timer may be (re)started when the UE performs a (DL/UL) transmission.

In some implementations, the timer may be (re)started when the UE receives an indication from a BS (e.g., DCI and/or a DRX command MAC CE, and/or an RRC configuration).

In some implementations, the timer may be stopped when the UE has switched the DRX cycle to a first DRX cycle and/or a second DRX cycle.

In some implementations, the timer may be stopped when the UE receives an indication from a BS (e.g., a DRX command MAC CE).

In some implementations, the UE may monitor a PDCCH (e.g., based on the specific RNTI, search space, and/or CORESET for the XR) while the timer is running.

In some implementations, the UE may determine an Active Time while the timer is running.

In some implementations, the UE may switch the DRX cycles based on a counter.

In some implementations, when a counter reaches to a maximum value, the UE may switch the DRX cycles (e.g., for a MAC entity/DRX group/DRX configuration/Cell Group (e.g., the MCG/SCG)/cell/serving cell/BWP/set of cells). In some implementations, the counter may count a number of DRX cycles. In some implementations, the value of the counter may be increased by 1 when a DRX cycle starts and/or ends. In some implementations, the counter may be reset when the UE has switched the DRX cycle to a first DRX cycle and/or a second DRX cycle. In some implementations, the counter may be reset when the UE performs a (DL/UL) transmission. In some implementations, the counter may be reset when the UE receives an indication from a BS (e.g., DCI, a DRX command MAC CE, and/or an RRC configuration).

In some implementations, the UE may switch the DRX cycles after an offset from the time that the above-mentioned criterion (e.g., based on an indication, a configuration, an event, a timer, and/or a counter) is fulfilled. In some implementations, the offset may be configured by the BS. In some implementations, the offset may be a DRX start offset, a DRX slot offset, and/or a DRX offset. In some implementations, the offset may be a processing time, a switch delay, and/or an application delay for the UE.

### DRX Cycle/DRX Cycle Timer/DRX Command MAC CE

If DRX Timer Expires and/or if DRX Command MAC CE is Received

In some implementations, if a specific DRX timer (e.g., for a MAC entity/DRX group/DRX configuration/Cell Group (e.g., the MCG/SCG)/cell/serving cell/BWP/set of cells) expires, the UE may determine whether the specific DRX cycle (e.g., with a non-integer value) and/or the value for deriving the specific DRX cycle is configured to determine whether to use the DRX specific cycle (e.g., with a non-integer value) and/or the value for deriving the specific DRX cycle.

In some implementations, the specific DRX timer may be a DRX inactivity timer, DRX on-duration timer, DRX retransmission timer for a DL, a DRX retransmission timer for a UL, a DRX HARQ RTT timer for a DL, a DRX HARQ RTT timer for a UL, a DRX short cycle timer, an XR-specific DRX timer, etc.

In some implementations, if the specific DRX timer (e.g., for a MAC entity/DRX group/DRX configuration/Cell Group (e.g., the MCG/SCG)/cell/serving cell/BWP/set of cells) expires, the UE may use the short DRX cycle (e.g., with an integer value), a long DRX cycle (e.g., with an integer value), and/or a specific DRX cycle (e.g., with a non-integer value) (e.g., for a MAC entity/DRX group/DRX configuration/Cell Group (e.g., the MCG/SCG)/cell/serving cell/BWP/set of cells). Specifically, the specific DRX timer may be configured for the XR. The specific DRX timer may be configured in the specific DRX configuration. The specific DRX timer may be configured for a non-integer DRX cycle.

In some implementations, if the UE receives a specific indication (e.g., a DRX command MAC CE) from a BS (e.g., for a MAC entity/DRX group/DRX configuration/Cell Group (e.g., the MCG/SCG)/cell/serving cell/BWP/set of cells), the UE may determine whether the specific DRX cycle (e.g., with a non-integer value) and/or the value for deriving the specific DRX cycle is configured to determine whether to use the DRX specific cycle (e.g., with a non-integer value) and/or the value for deriving the specific DRX cycle.

In some implementations, the specific indication (e.g., a DRX command MAC CE) may be a DRX command MAC CE, a short DRX command MAC CE, a Long DRX command MAC CE, a non-integer DRX command MAC CE, and/or an XR-specific DRX command MAC CE.

In some implementations, the specific indication (e.g., a DRX command MAC CE) may be a fixed size of zero bit.

In some implementations, the specific indication (e.g., a DRX command MAC CE) may indicate information of a MAC entity/DRX group/DRX configuration/Cell Group (e.g., the MCG/SCG)/cell/serving cell/BWP/set of cells.

In some implementations, the specific indication may indicate whether to use a specific DRX cycle or a legacy DRX cycle of one or multiple cells/serving cells/BWPs/sets of cells. The specific indication may include a bitmap. Each bit of the bitmap may map to a cell/serving cell/BWP/set of cells. When a first value is indicated by a bit in the bitmap, the cell/serving cell/BWP/set of cells that maps to the corresponding bit may use a specific DRX cycle/configuration. When a second value is indicated by a bit in the bitmap, the cell/serving cell/BWP/set of cells that maps to the corresponding bit may use a legacy DRX cycle/configuration. Using a legacy/specific DRX cycle/configuration may imply applying the timer values of the legacy/specific DRX cycle/configuration.

In some implementations, the specific indication (e.g., a DRX command MAC CE) may be received on a specific CORESET/search space/PDCCH. The specific CORESET/search space/PDCCH may be explicitly configured for the XR services (e.g., for monitoring a UL/DL scheduling of the XR services).

In some implementations, the specific indication (e.g., a DRX command MAC CE) may indicate the specific DRX cycle.

In some implementations, the specific DRX cycles may be a non-integer DRX cycle. In some implementations, the non-integer DRX cycle may be indicated by one or more decimals (e.g., 33.33 ms, 16.67 ms, 11.11 ms, 8.33 ms, etc.). In some implementations, the non-integer DRX cycle may be indicated by one or more fractions (e.g., 100/3, 50/3, 25/3, etc.). In some implementations, the DRX cycle may be a specific DRX cycle (e.g., a short DRX cycle, a long DRX cycle, a non-integer DRX cycle, and/or an XR DRX cycle).

In some implementations, the specific indication (e.g., a DRX command MAC CE) may indicate the value for deriving the specific DRX cycle.

In some implementations, the value for deriving the specific DRX may be an integer/denominator/fraction/decimal. In some implementations, the value may be associated with a periodicity of the XR traffic and/or the fps of the XR application.

In some implementations, the value may be used to derive a DRX cycle. Specifically, the UE may use a DRX cycle (e.g., a short DRX cycle and/or a long DRX cycle) and the value to derive a specific DRX cycle (e.g., a non-integer DRX cycle). The UE may determine that a specific DRX cycle (e.g., a non-integer DRX cycle) is a DRX cycle (e.g., a short DRX cycle and/or a long DRX cycle) divided by the value.

In some implementations, the value for deriving the specific DRX may (only) be configured when a DRX cycle (e.g., a short DRX cycle and/or a long DRX cycle) is configured.

### Alternatives of UE Behaviors for DRX Cycle/DRX Cycle Timer

In some implementations, if the UE determines that the specific DRX cycle (e.g., with a non-integer value) and/or the value for deriving the specific DRX cycle is configured, the UE may start or restart the drx-ShortCycle Timer (e.g., for a MAC entity/DRX group/DRX configuration/Cell Group (e.g., the MCG/SCG)/cell/serving cell/BWP/set of cells) in the first symbol after the expiry of the drx-InactivityTimer and/or (e.g., at a period) after determining that the specific DRX cycle (e.g., with a non-integer value) and/or the value for deriving the specific DRX cycle is configured (e.g., after receiving the specific indication to indicate that the specific DRX cycle is used).

In some implementations, if the drx-ShortCycle Timer expires, the UE may use the Long DRX cycle (e.g., for a MAC entity/DRX group/DRX configuration/Cell Group (e.g., the MCG/SCG)/cell/serving cell/BWP/set of cells).

In some implementations, if the UE determines that the specific DRX cycle (e.g., with a non-integer value) and/or the value for deriving the specific DRX cycle is configured, the UE may start or restart a specific Timer (e.g., a DRX cycle timer for XR) (e.g., for a MAC entity/DRX group/DRX configuration/Cell Group (e.g., the MCG/SCG)/cell/serving cell/BWP/set of cells) in the first symbol after the expiry of the drx-InactivityTimer and/or (e.g., at a period) after determining that the specific DRX cycle and/or the value for deriving the specific DRX cycle is configured (e.g., after receiving the specific indication to indicate that the specific DRX cycle is used).

In some implementations, if the specific timer (e.g., a DRX cycle timer for XR) expires, the UE may use the short DRX cycle, the long DRX cycle, and/or a specific DRX cycle (e.g., with a non-integer value) (e.g., for a MAC entity/DRX group/DRX configuration/Cell Group (e.g., the MCG/SCG)/cell/serving cell/BWP/set of cells). In some implementations, the specific timer may be configured for the XR. In some implementations, the specific timer may be configured in the specific DRX configuration. In some implementations, the specific timer may be configured for a non-integer DRX cycle.

In some implementations, if the UE determines that the specific DRX cycle (with a non-integer value) and/or the value for deriving the specific DRX cycle is not configured, the UE may start or restart the drx-ShortCycle Timer (e.g., for a MAC entity/DRX group/DRX configuration/Cell Group (e.g., the MCG/SCG)/cell/serving cell/BWP/set of cells) in the first symbol after the expiry of the drx-InactivityTimer.

In some implementations, if the UE determines that the specific DRX cycle (e.g., with a non-integer value) and/or the value for deriving the specific DRX cycle is not configured, the UE may start or restart a specific Timer (e.g., a DRX cycle timer for XR) (e.g., for a MAC entity/DRX group/DRX configuration/Cell Group (e.g., the MCG/SCG)/cell/serving cell/BWP/set of cells) in the first symbol after the expiry of the drx-InactivityTimer.

In some implementations, if the specific DRX cycle (e.g., with a non-integer value) and/or the value for deriving the specific DRX cycle is configured, the UE may use the specific DRX cycle and/or the value for deriving the specific DRX cycle is configured (e.g., for a MAC entity/DRX group/DRX configuration/Cell Group (e.g., the MCG/SCG)/cell/serving cell/BWP/set of cells). In some implementations, the specific DRX cycle may be a short non-integer DRX cycle. In some implementations, the specific DRX cycle may be a long non-integer DRX cycle.

In some implementations, if the specific DRX cycle (e.g., with a non-integer value) and/or the value for deriving the specific DRX cycle is configured, the UE may use the Short DRX cycle (for a MAC entity/DRX group/DRX configuration/Cell Group (e.g., the MCG/SCG)/cell/serving cell/BWP/set of cells).

In some implementations, if the specific DRX cycle (e.g., with a non-integer value) and/or the value for deriving the specific DRX cycle is configured, the UE may use the Long DRX cycle (e.g., for a MAC entity/DRX group/DRX configuration/Cell Group (e.g., the MCG/SCG)/cell/serving cell/BWP/set of cells).

In some implementations, if the specific DRX cycle (e.g., with a non-integer value) and/or the value for deriving the specific DRX cycle is not configured, the UE may use the Short DRX cycle (e.g., for a MAC entity/DRX group/DRX configuration/Cell Group (e.g., the MCG/SCG)/cell/serving cell/BWP/set of cells).

In some implementations, if the specific DRX cycle (e.g., with a non-integer value) and/or the value for deriving the specific DRX cycle is not configured, the UE may use the Long DRX cycle (e.g., for a MAC entity/DRX group/DRX configuration/Cell Group (e.g., the MCG/SCG)/cell/serving cell/BWP/set of cells).

### DRX On-Duration Timer/DRX Start Offset/DRX Slot Offset

In some implementations, the UE may determine whether to (re)start a DRX timer (e.g., a DRX on-duration timer) (e.g., for a MAC entity/DRX group/DRX configuration/Cell Group (e.g., the MCG/SCG)/cell/serving cell/BWP/set of cells) based on the specific DRX cycle.

In some implementations, the DRX timer (e.g., a DRX on-duration timer) may be (re)started after (e.g., shifted by) a time offset from a specific time.

In some implementations, the DRX timer (e.g., a DRX on-duration timer) may be (re)started after (e.g., shifted by) a time offset+a drx-SlotOffset from a specific time.

In some implementations, the DRX timer (e.g., a DRX on-duration timer) may be (re)started before (e.g., shifted by) a time offset from a specific time.

In some implementations, the DRX timer (e.g., a DRX on-duration timer) may be (re)started before (e.g., shifted by) a time offset+a drx-SlotOffset from a specific time.

In some implementations, the specific DRX cycle may be (re)started after (e.g., shifted by) a start offset from a specific time.

In some implementations, the specific DRX cycle may be (re)started after (e.g., shifted by) a start offset+drx-StartOffset from a specific time.

In some implementations, the specific DRX cycle may be (re)started before (e.g., shifted by) a start offset from a specific time.

In some implementations, the specific DRX cycle may be (re)started before (shifted by) a start offset+drx-StartOffset from a specific time.

In some implementations, the UE may determine whether to (re)start a DRX timer (e.g., DRX on-duration timer) (e.g., for a MAC entity/DRX group/DRX configuration/Cell Group (e.g., the MCG/SCG)/cell/serving cell/BWP/set of cells) based on the specific DRX cycle, the time offset, and/or the start offset.

In some implementations, the UE may determine whether to (re)start a DRX timer (e.g., a DRX on-duration timer) (e.g., for a MAC entity/DRX group/DRX configuration/Cell Group (e.g., the MCG/SCG)/cell/serving cell/BWP/set of cells) based on the specific DRX cycle, the time offset, the drx-SlotOffset, the start offset, and/or the drx-StartOffset. Specifically, the DRX timer may be a DRX inactivity timer, a DRX on-duration timer, a DRX retransmission timer for a DL, a DRX retransmission timer for a UL, a DRX HARQ RTT timer for a DL, a DRX HARQ RTT timer for a UL, a DRX short cycle timer, an XR-specific DRX timer, etc.

In some implementations, if the specific DRX cycle is used (e.g., for a MAC entity/DRX group/DRX configuration/Cell Group (e.g., the MCG/SCG)/cell/serving cell/BWP/set of cells), and [(SFN×10)+subframe number] modulo (the specific DRX cycle)=(a start offset) modulo (the specific DRX cycle), the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells), e.g., before/after (e.g., shifted by) a time offset from a specific time.

In some implementations, if the specific DRX cycle is used (e.g., for a MAC entity/DRX group/DRX configuration/Cell Group (e.g., the MCG/SCG)/cell/serving cell/BWP/set of cells), and [(SFN×10)+subframe number] modulo (the specific DRX cycle)=(a start offset+drx-StartOffset) modulo (the specific DRX cycle), the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells), e.g., before/after (e.g., shifted by) a time offset+a drx-SlotOffset from a specific time.

In some implementations, if the specific DRX cycle is used (e.g., for a MAC entity/DRX group/DRX configuration/Cell Group (e.g., the MCG/SCG)/cell/serving cell/BWP/set of cells), and [(SFN×10)+subframe number] modulo (the specific DRX cycle)=a start offset, the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells), e.g., before/after (e.g., shifted by) a time offset from a specific time.

In some implementations, if the specific DRX cycle is used (e.g., for a MAC entity/DRX group/DRX configuration/Cell Group (MCG/SCG)/cell/serving cell/BWP/set of cells), and [(SFN×10)+subframe number] modulo (the specific DRX cycle)=(a start offset+drx-StartOffset), the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells), e.g., before/after (e.g., shifted by) a time offset+a drx-SlotOffset from a specific time.

In some implementations, if the specific DRX cycle is used (e.g., for a MAC entity/DRX group/DRX configuration/Cell Group (e.g., the MCG/SCG)/cell/serving cell/BWP/set of cells), the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells) before/after (e.g., shifted by) a start offset from the beginning/start (e.g., the first slot/symbol) of the specific DRX cycle.

In some implementations, if the specific DRX cycle is used (e.g., for a MAC entity/DRX group/DRX configuration/Cell Group (e.g., the MCG/SCG)/cell/serving cell/BWP/set of cells), the UE may (re)start a DRX timer (e.g., a DRX on-duration timer) (e.g., for a MAC entity/DRX group/DRX configuration/Cell Group (e.g., the MCG/SCG)/cell/serving cell/BWP/set of cells) before/after (e.g., shifted by) a start offset+drx-StartOffset from the beginning/start (e.g., the first slot/symbol) of the specific DRX cycle. Specifically, the specific DRX cycle may be a short DRX cycle, a long DRX cycle, a non-integer DRX cycle, and/or an XR DRX cycle.

### Details of Time Offset/Start Offset

In some implementations, the time offset may be in a unit of slot, symbol, subframe, system frame, ms, second, and/or DRX cycle. Specifically, the time offset may be a DRX offset (e.g., the drx-SlotOffset) used for the delay before starting the drx-onDurationTimer. The value of the time offset may be zero, an integer, a non-integer, a positive number, and/or a negative number. If the value of the time offset is a negative number, the UE may (re)start the DRX timer before the specific time. The time offset may be the start of the specific DRX timer relative to the start/end of the specific time.

In some implementations, the start offset may be in a unit of slot, symbol, subframe, system frame, and/or ms, seconds, and/or DRX cycle. Specifically, the start offset (e.g., the drx-StartOffset) may define a subframe/slot/symbol where a specific DRX cycle starts. The value of the start offset may be zero, an integer, a non-integer, a positive number, and/or a negative number. If the value of the start offset is a negative number, the UE may (re)start the specific DRX cycle before the specific time. The start offset may be the start of the specific DRX cycle relative to the start/end of the specific time. The configuration of the start offset may be included in a specific DRX configuration (e.g., for the XR) configured by a BS. The specific DRX cycle may be a short DRX cycle, a long DRX cycle, a non-integer DRX cycle, and/or an XR DRX cycle.

In some implementations, the specific time may be in a unit of slot, symbol, subframe, system frame, and/or ms, seconds, and/or DRX cycle. Specifically, the specific time may be the beginning/start (e.g., the first slot/symbol) of the specific DRX cycle. The specific time may be the end (e.g., the last slot/symbol) of the specific DRX cycle. The specific time may be the start of a DRX timer (e.g., a DRX inactivity timer, a DRX on-duration timer, a DRX retransmission timer for a DL, a DRX retransmission timer for a UL, a DRX HARQ RTT timer for a DL, a DRX HARQ RTT timer for a UL, a DRX short cycle timer, an XR-specific DRX timer, etc.).

In some implementations, the configuration of the time offset and/or the start offset may be configured by a BS (e.g., the configuration of the time offset and/or the start offset may be included in a specific DRX configuration).

In some implementations, the configuration of the time offset and/or the start offset may be configured per MAC entity (e.g., the configuration of the time offset and/or the start offset may be included in the MAC-CellGroupConfig).

In some implementations, the configuration of the time offset and/or the start offset may be configured per DRX group (e.g., the configuration of the time offset and/or the start offset may be included in the secondaryDRX-GroupConfig, the DRX-ConfigSecondaryGroup, and/or a DRX group for the XR). Specifically, the DRX group may be specifically configured for the XR. The NW may configure the DRX group to be specifically for the XR via a specific configuration/IE.

In some implementations, the configuration of the time offset and/or the start offset may be configured per DRX configuration (e.g., the configuration of the time offset and/or the start offset may be included in the DRX-Config and/or the DRX-Config2 and/or an XR DRX configuration).

In some implementations, the configuration of the time offset and/or the start offset may be configured per Cell Group (e.g., the MCG/SCG) (e.g., the configuration of the time offset and/or the start offset may be included in the CellGroupConfig). For example, the specific DRX configuration is configured for a specific Cell Group (e.g., the MCG/SCG).

In some implementations, the configuration of the time offset and/or the start offset may be configured per cell/serving cell (e.g., the configuration of the time offset and/or the start offset may be included in the SpCellConfig or the SCellConfig). Specifically, the cell/serving cell may be specifically configured for the XR. The NW may configure the cell/serving cell to be specifically for the XR via a specific configuration/IE.

In some implementations, the configuration of the time offset and/or the start offset may be configured per BWP (e.g., the configuration of the time offset and/or the start offset may be included in a BWP configuration). Specifically, the BWP may be specifically configured for the XR. The NW may configure the BWP to be specifically for the XR via a specific configuration/IE.

In some implementations, the configuration of the time offset and/or the start offset may be configured per set/group of cells. Specifically, the UE may be configured with one or more sets/groups of cells. The set/group of cells may include one or more cells. The set/group of cells may include the SpCell and/or SCell(s). The UE may be indicated that each cell is related to which set/group of cells. The set/group of cells may correspond to a specific FR (e.g., the FR1 and/or the FR2). The set/group of cells may correspond to the dormancy SCell group(s). The set of cells may be specifically configured for the XR. The NW may configure the set/group of cells to be specifically for the XR via a specific configuration/IE.

In some implementations, the UE may apply the time offset and/or the start offset for a MAC entity/DRX group/DRX configuration/Cell Group (e.g., the MCG/SCG)/cell/serving cell/BWP/set of cells which is configured with the time offset and/or the start offset.

In some implementations, the UE may apply the time offset and/or the start offset for a MAC entity/DRX group/DRX configuration/Cell Group (e.g., the MCG/SCG)/cell/serving cell/BWP/set of cells which is not configured with the specific DRX configuration.

### Adjustment/Update of Time Offset/Start Offset

In some implementations, the UE may adjust/update the value of the time offset/start offset based on a rate (e.g., a drift rate).

In some implementations, the rate may be indicated by DCI, a MAC CE, and/or an RRC configuration.

In some implementations, the rate may indicate the value for the UE to adjust/update the value of the time offset/start offset. The value X for the UE to adjust/update the value of the time offset/start offset may be in a unit of slot, symbol, subframe, system frame, ms, second, and/or DRX cycle.

In some implementations, the rate may indicate a value Y for how long (e.g., via a time unit) the UE needs to adjust/update the value of the time offset/start offset. The value Y may correspond to the periodicity of the XR traffic/fps (e.g., 33.33 ms, 16.67 ms, 11.11 ms, 8.33 ms).

In some implementations, if the rate indicates X ms per Y DRX cycles, the UE needs to adjust/update/add the value of the time offset/start offset by X ms per DRX cycles.

In some implementations, the UE may adjust/update the value of the time offset/start offset based on a value of a counter which is associated with the rate.

### Switching of Time Offset/Start Offset

In some implementations, the UE may switch/change the value/configuration of the time offset and/or the start offset (e.g., for a MAC entity/DRX group/DRX configuration/Cell Group (e.g., the MCG/SCG)/cell/serving cell/BWP/set of cells) based on one or more criteria (e.g., an indication, a configuration, an event, a timer, and/or a counter). The UE switching the DRX cycles may imply that the UE replaces a first DRX cycle with a second DRX cycle.

In some implementations, the UE may switch from a first time offset and/or start offset to a second time offset and/or start offset based on one or more criteria (e.g., an indication, a configuration, an event, a timer, and/or a counter).

In some implementations, after the UE switches to a second time offset and/or start offset, the UE may switch back to a first time offset and/or start offset based on one or more criteria (e.g., an indication, a configuration, an event, a timer, and/or a counter).

### Alternatives for Switching Time Offset/Start Offset

In some implementations, the UE may switch/change the value/configuration of the time offset and/or the start offset (e.g., for a MAC entity/DRX group/DRX configuration/Cell Group (e.g., the MCG/SCG)/cell/serving cell/BWP/set of cells) based on an indication and/or a configuration received from a BS.

In some implementations, when the UE receives an indication and/or a configuration from a BS, the UE may switch a first time offset and/or a start offset to a second time offset and/or a start offset (e.g., for a MAC entity/DRX group/DRX configuration/Cell Group (e.g., the MCG/SCG)/cell/serving cell/BWP/set of cells).

In some implementations, the UE may determine whether to switch the time offset and/or the start offset (e.g., for a MAC entity/DRX group/DRX configuration/Cell Group (e.g., the MCG/SCG)/cell/serving cell/BWP/set of cells) based on an indication and/or a configuration.

In some implementations, the UE may determine to switch the first time offset and/or the start offset (e.g., for a MAC entity/DRX group/DRX configuration/Cell Group (e.g., the MCG/SCG)/cell/serving cell/BWP/set of cells) to the second time offset and/or the start offset based on the indication and/or based on a configuration.

In some implementations, the indication may be received via DCI, a MAC CE, and/or an RRC configuration. Specifically, the indication may indicate the value/configuration of the time offset and/or the start offset. The indication may indicate information of a MAC entity/DRX group/DRX configuration/Cell Group (e.g., the MCG/SCG)/cell/serving cell/BWP/set of cells. The indication may indicate the specific DRX cycle. The indication may indicate the value for deriving the specific DRX cycle. The indication may be a UL grant and/or a DL assignment that schedules the XR traffics. The indication may be DCI received on a PDCCH/search space/CORESET configured for the XR traffics. The indication may be a PDCCH/DCI addressed to a specific RNTI (e.g., the XR-RNTI). The indication may be a PDCCH/DCI monitored/received on a specific search space/CORESET (e.g., for the XR). The indication may be a PDCCH/DCI with a specific DCI format (e.g., for the XR). The indication may be a PDSCH including the XR traffics. In some implementations, the PUSCH may correspond to a specific SPS configured for the XR services.

In some implementations, the configuration may be received via DCI, a MAC CE, and/or an RRC configuration. Specifically, the configuration may indicate the value/configuration of the time offset and/or the start offset. The configuration may indicate information of a MAC entity/DRX group/DRX configuration/Cell Group (e.g., the MCG/SCG)/cell/serving cell/BWP/set of cells. The indication may indicate the specific DRX cycle. The indication may indicate the value for deriving the specific DRX cycle.

In some implementations, the UE may switch the time offset and/or the start offset based on an event.

In some implementations, if the UE transmits specific information to a BS, the UE may switch the time offset and/or the start offset (e.g., for a MAC entity/DRX group/DRX configuration/Cell Group (e.g., the MCG/SCG)/cell/serving cell/BWP/set of cells). Specifically, the specific information may indicate information for the XR traffic pattern/XR application/frame per second/periodicity for the DRX/pose control information. The specific information may indicate a HARQ feedback (e.g., the HARQ ACK/NACK) (e.g., for DCI, a PDSCH transmission, and/or the indication for switching the DRX cycle). The specific information may indicate that the UE prefers the non-integer DRX cycle. The specific information may be a PUSCH including an XR traffic. In some implementations, the PUSCH may correspond to a CG configured specifically for the XR services.

In some implementations, the UE may switch the time offset and/or the start offset based on a timer and/or a duration (e.g., configured by a BS).

In some implementations, when a timer expires, the UE may switch the time offset and/or the start offset (e.g., for a MAC entity/DRX group/DRX configuration/Cell Group (e.g., the MCG/SCG)/cell/serving cell/BWP/set of cells). In some implementations, the timer may be a DRX timer, a specific DRX inactivity timer, a DRX on-duration timer, a DRX retransmission timer for a DL, a DRX retransmission timer for a UL, a DRX HARQ RTT timer for a DL, a DRX HARQ RTT timer for a UL, a DRX short cycle timer, an XR-specific DRX timer, etc. In some implementations, the timer may be (re)started when the UE has switched the time offset and/or the start offset to a first time offset, the start offset, a time offset, and/or the start offset. In some implementations, the timer may be (re)started when the UE performs a (DL/UL) transmission. In some implementations, the timer may be (re)started when the UE receives an indication from a BS (e.g., DCI and/or a DRX command MAC CE, and/or an RRC configuration). In some implementations, the timer may be stopped when the UE has switched the time offset and/or the start offset to a first time offset, the start offset, a second time offset, and/or the start offset. In some implementations, the timer may be stopped when the UE receives an indication from a BS (e.g., a DRX command MAC CE). In some implementations, the UE may monitor a PDCCH (e.g., based on the specific RNTI, search space, and/or CORESET for the XR) while the timer is running. In some implementations, the UE may determine an Active Time while the timer is running.

In some implementations, the UE may switch the time offset and/or the start offset based on a counter.

In some implementations, when a counter reaches to a maximum value, the UE may switch the time offset and/or the start offset (e.g., for a MAC entity/DRX group/DRX configuration/Cell Group (e.g., the MCG/SCG)/cell/serving cell/BWP/set of cells). In some implementations, the counter may count a number of DRX cycles. In some implementations, a value of the counter may be increased by 1 when a DRX cycle starts and/or ends. In some implementations, the counter may be reset when the UE has switched the time offset and/or the start offset to a first time offset, the start offset, a second time offset, and/or the start offset. In some implementations, the counter may be reset when the UE performs a (DL/UL) transmission. In some implementations, the counter may be reset when the UE receives an indication from a BS (e.g., DCI, a DRX command MAC CE, and/or an RRC configuration).

In some implementations, the UE may switch the time offset and/or the start offset after an offset from a time that the above-mentioned criterion (e.g., based on an indication, a configuration, an event, a timer, and/or a counter) is fulfilled. Specifically, the offset may be configured by the BS. The offset may be a DRX start offset, a DRX slot offset, and/or a DRX offset. The offset may be a processing time, a switch delay, and/or an application delay for the UE.

### Determination Between Time Offset/Start Offset and Legacy Drx-SlotOffset/Drx-StartOffset

In some implementations, if the UE is an XR-specific UE (e.g., the UE has the XR capability), the UE may apply the time offset/the start offset. Alternatively, the UE may apply the legacy drx-SlotOffset/drx-StartOffset.

In some implementations, if the UE transmits specific information to a BS, the UE may apply the time offset/the start offset. Alternatively, the UE may apply the legacy drx-SlotOffset/drx-StartOffset.

In some implementations, the specific information may be transmitted via an assistance information/UEAssistanceInformation IE (e.g., the assistance information for XR, for a non-integer DRX cycle, and/or for a DRX preference).

In some implementations, the specific information may be transmitted via a UE capability information/UECapabilityInformation IE (e.g., the UE capability information for the XR, for a non-integer DRX cycle, and/or for a DRX preference).

In some implementations, the specific information may indicate that information for the XR traffic pattern/XR application/frame per second/periodicity for the DRX/pose control information.

In some implementations, the specific information may indicate that the UE prefers the non-integer DRX cycle.

In some implementations, the specific information may be transmitted via an RRC message, a MAC CE (e.g., an SR, a BSR, and/or an XR MAC CE), and/or PHY signaling (e.g., on a PUCCH).

In some implementations, if the UE is performing a procedure for the XR, the UE may apply the time offset/the start offset. Alternatively, the UE may apply the legacy drx-SlotOffset/drx-StartOffset.

In some implementations, the UE may enter/initiate/perform a procedure for the XR when data arrives at a specific LCH/SRB/DRB for the XR services and/or when the UE has pended the data from the specific LCH/SRB/DRB for the XR services. The specific LCH/SRB/DRB configuration for the XR services may be configured by the NW for conveying the XR data.

In some implementations, the UE may enter/initiate/perform a procedure for the XR when the UE triggers/initiates a BSR/SR/RA from a specific LCH/SRB/DRB for the XR services.

In some implementations, the UE may enter/initiate/perform a procedure for the XR when the UE receives scheduling information that schedules a UL/DL resource for transmitting the UL/DL XR traffics. Alternatively, the UE may enter/initiate/perform a procedure for XR when the UE (successfully/unsuccessfully) receives the XR traffics on a DL resource (e.g., a PDSCH) and/or transmits the XR traffics on a UL resource (e.g., a PUSCH).

In some implementations, the UE may enter/initiate/perform a procedure for the XR when the UE receives specific indication from the BS. The specific indication may indicate to the UE to enter/initiate/perform a procedure for the XR. The indication may be transmitted via an RRC message, a MAC CE (e.g., an XR MAC CE), and/or PHY signaling (e.g., on a PDCCH).

In some implementations, if the UE receive specific indication, from a BS, the UE may apply the time offset/the start offset. Alternatively, the UE may apply the legacy drx-SlotOffset/drx-StartOffset.

In some implementations, the specific indication may indicate to the UE to enter/initiate/perform a procedure for the XR.

In some implementations, the indication may be transmitted via an RRC message, a MAC CE (e.g., an XR MAC CE), and/or PHY signaling (e.g., on a PDCCH).

In some implementations, if the UE is configured with a specific configuration/IE, the UE may apply the time offset/the start offset. Alternatively, the UE may apply the legacy drx-SlotOffset/drx-StartOffset.

In some implementations, the specific configuration/IE may indicate scheduling information for the XR traffic.

In some implementations, the specific configuration/IE may trigger a procedure for the XR.

In some implementations, the specific configuration/IE may be a specific CG/SPS configuration for the XR services. The specific CG/SPS configuration for the XR services may be configured by the NW for transmitting the UL/DL XR data.

In some implementations, the specific configuration/IE may be a specific LCH/SRB/DRB for the XR services. The specific LCH/SRB/DRB configuration for the XR services may be configured by the NW for conveying the XR data.

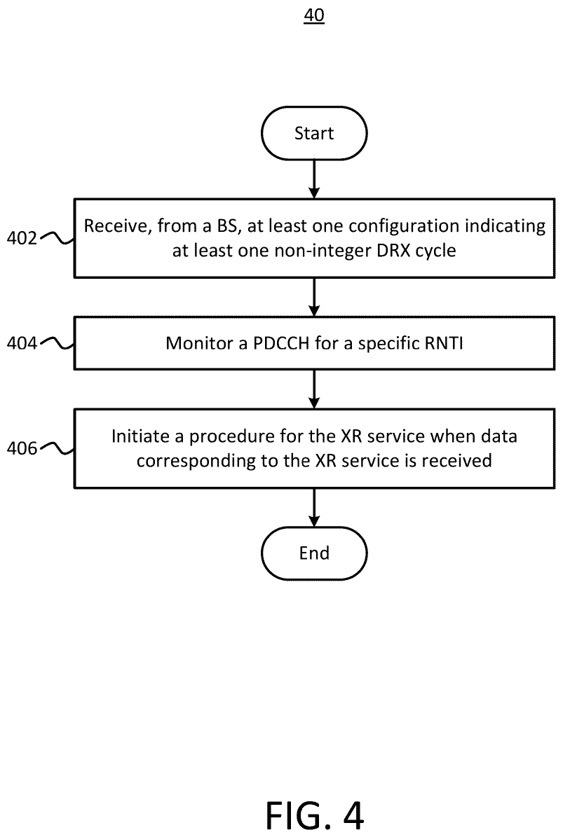

FIG. 4 is a flowchart illustrating a method/process 40 performed by a UE for an XR service, according to an example implementation of the present disclosure. In the example of FIG. 4, the actions of the method/process 40, as illustrated in the figure, are separate actions that are represented as independent blocks. In some other implementations, these separate actions may not be construed as necessarily order dependent, where any two or more actions may also be performed and/or combined with each other or be integrated with other alternate actions that are not limiting the scope of the disclosure. Moreover, in some implementations, one or more of the actions may be adaptively omitted.

As shown in FIG. 4, the method/process 40 for the UE may start by receiving, in action 402, from a BS, at least one configuration indicating at least one non-integer DRX cycle.

In action 404, the process 40 may monitor a PDCCH for a specific RNTI.

In action 406, the process 40 may initiate a procedure for the XR service when data corresponding to the XR service is received. The process 40 may then end.

In some implementations, in action 402, the UE may receive at least one configuration indicating at least one non-integer DRX cycle from the BS. In action 404, the UE may monitor the PDCCH for a specific RNTI. Specifically, the UE may monitor the PDCCH based on an XR-RNTI and continue for a DRX active period based on a specific DRX configuration from the BS. In action 406, the UE may initiate a procedure for the XR service when data corresponding to the XR service is received.

In some implementations, if the second parameter indicates a first HARQ reporting mode of the HARQ feedback, the UE may provide the HARQ-ACK information to the BS in response to receiving the first PDSCH. Alternatively, if the second parameter indicates a second HARQ reporting mode of the HARQ feedback, the UE may provide the HARQ-ACK information to the BS only when the UE fails to decode the first PDSCH.

In some implementations, the procedure 40 may further configure the UE to switch the at least one DRX cycle based on an indication or a configuration received from the BS. In some implementation, the procedure 40 may further configure the UE to transmit specific information indicating a UE capability information to the BS. Specifically, the specific information may include an assistance information Information Element (IE) or a UE capability information IE.

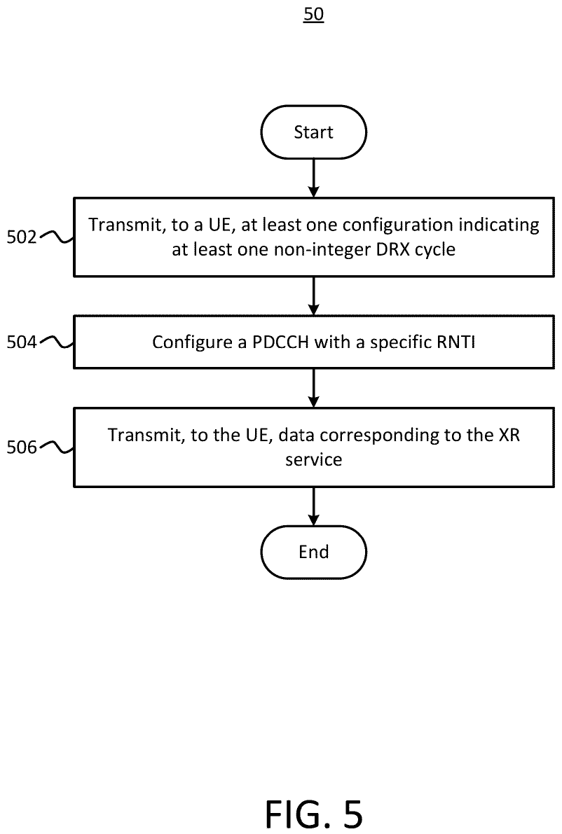

FIG. 5 is a flowchart illustrating a method/process 50 performed by a BS for an XR service, according to an example implementation of the present disclosure. Similarly, in the example of FIG. 5, the actions of the method/process 50, as illustrated in the figure, are separate actions that are represented as independent blocks. In some other implementations, these separate actions may not be construed as necessarily order dependent, where any two or more actions may also be performed and/or combined with each other or be integrated with other alternate actions that are not limiting the scope of the disclosure. Moreover, in some implementations, one or more of the actions may be adaptively omitted.

As shown in FIG. 5, the method/process 50 for the BS may start by transmitting, to a UE, at least one configuration indicating at least one non-integer DRX cycle.

In action 504, the process 50 may configure a PDCCH with a specific RNTI.

In action 506, the process 50 may transmit, to the UE, data corresponding to the XR service. The process 50 may then end.

In some implementations, in action 502, the BS may transmit at least one configuration indicating at least one non-integer DRX cycle to the UE. In action 504, the BS may configure the PDCCH with the specific RNTI. In action 506, the BS may transmit the data corresponding to the XR service to the UE.

In some implementations, the method/process 50 may further configure the BS to configure an indication or a configuration to the UE for switching the at least one DRX cycle. In some implementation, the method/process 50 may further configure the BS to configure an XR-RNTI to the UE for monitoring the PDCCH and configure a specific DRX configuration to the UE for transmission in a DRX active period. In some implementation, the method/process 50 may further configure the BS to receive, from the UE, specific information indicating a UE capability information, where the specific information may include an assistance information IE or a UE capability information IE.

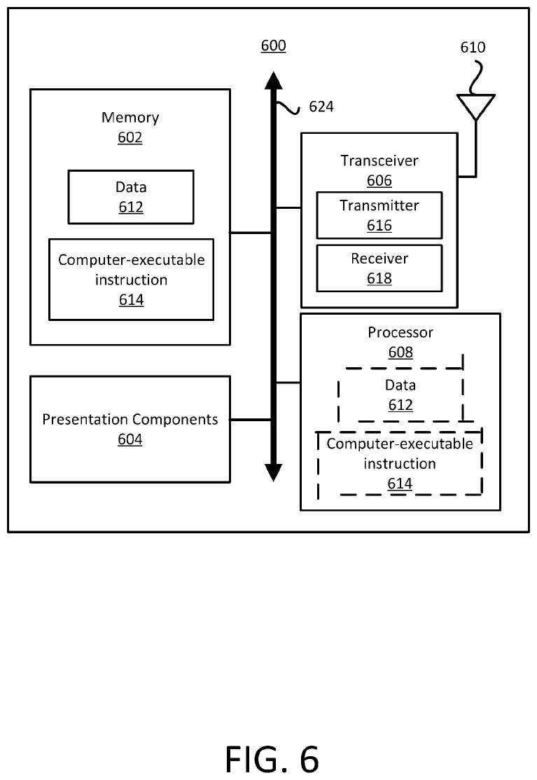

FIG. 6, which is a block diagram illustrating a node 600 for wireless communication, according to an example implementation of the present disclosure. As illustrated in FIG. 6, the node 600 includes a transceiver 606, a processor 608, a memory 602, one or more presentation components 604, and at least one antenna 610. The node 600 may also include an RF spectrum band module, a BS communications module, an NW communications module, and a system communications management module, input/output (I/O) ports, I/O components, and power supply (not explicitly illustrated in FIG. 6). Each of these components may be in communication with each other, directly or indirectly, over one or more buses 624. The node 600 may be a UE, an NW, a cell/BS or any operating entity in the wireless communication system that performs various functions disclosed herein, for example, with reference to FIG. 4 and/or FIG. 5.

The transceiver 606 includes a transmitter 616 (e.g., transmitting/transmission circuitry) and a receiver 618 (e.g., receiving/reception circuitry) and may be configured to transmit and/or receive time and/or frequency resource partitioning information. The transceiver 606 may be configured to transmit in different types of subframes and slots, including, but not limited to, usable, non-usable, and flexibly usable subframes and slot formats. The transceiver 606 may be configured to receive data and control channels.

The node 600 may include a variety of computer-readable media. Computer-readable media may be any available media that may be accessed by the node 600 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information such as computer-readable media.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal, such as a carrier wave, or other transport mechanism and include any information delivery media.

The term “modulated data signal” may refer to a signal that has one or more of its characteristics set or changed in such a manner as to encode information in the signal. By way of example, and not limitation, communication media may include wired media, such as a wired NW or direct-wired connection, and wireless media, such as acoustic, RF, infrared, and other wireless media. Combinations of any of the previous disclosure should also be included within the scope of computer-readable media.

The memory 602 may include computer-storage media in the form of volatile and/or non-volatile memory. The memory 602 may be removable, non-removable, or a combination thereof. For example, the memory 602 may include solid-state memory, hard drives, optical-disc drives, etc.

As illustrated in FIG. 6, the memory 602 may store a computer-executable (or readable) program 614 (e.g., software codes or instructions) that are configured to, when executed, cause the processor 608 to perform various functions disclosed herein, for example, with reference to FIG. 4 and/or FIG. 5. Alternatively, the computer-executable instruction 614 may not be directly executable by the processor 608 but may be configured to cause the node 600 (e.g., when compiled and executed) to perform various functions disclosed herein.

The processor 608 (e.g., having processing circuitry) may include an intelligent hardware device, a CPU, a microcontroller, an ASIC, etc. The processor 608 may include memory. The processor 608 may process the data 612 and the computer-executable instruction 614 received from the memory 602, and information received via the transceiver 606, the baseband communications module, and/or the NW communications module. The processor 608 may also process information to be sent to the transceiver 606 for transmission through the antenna 610 to the NW communications module for subsequent transmission to a CN.

One or more presentation components 604 may present data to a person or other device. Examples of presentation components 604 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

1-15. (canceled)

16. A method performed by a user equipment (UE) for a discontinuous reception (DRX) operation, the method comprising:
receiving, from a base station (BS), a radio resource control (RRC) message for configuring one or more DRX configurations including at least a first DRX configuration that indicates parameters for an integer DRX cycle;
determining whether the one or more DRX configurations include a second DRX configuration that indicates parameters for a non-integer DRX cycle;
determining whether to apply the parameters for the integer DRX cycle or the parameters for the non-integer DRX cycle based one whether the one or more DRX configurations include the second DRX configuration or not;
starting, based on the parameters for the integer DRX cycle, a DRX timer in a case that the one or more DRX configurations do not include the second DRX configuration; and
starting, based on the parameters for the non-integer DRX cycle, the DRX timer in a case that the one or more DRX configurations include the second DRX configuration.

17. The method of claim 16, wherein:
the parameters for the non-integer DRX cycle are associated with a frame per second (FPS) of data traffic that is received by the UE, and
the parameters for the non-integer DRX cycle are indicated by decimal forms or fractional forms.

18. The method of claim 16, wherein the second DRX configuration is configured for a DRX group.

19. The method of claim 16, wherein:
the one or more DRX configurations include a third DRX configuration, and
the third DRX configuration indicates parameters for a second non-integer DRX cycle.

20. A user equipment (UE) for a discontinuous reception (DRX) operation, the UE comprising:
at least one processor; and
at least one non-transitory computer-readable medium coupled to the at least one processor, and storing one or more computer-executable instructions that, when executed by the at least one processor, cause the UE to:
receive, from a base station (BS), a radio resource control (RRC) message for configuring one or more DRX configurations including at least a first DRX configuration that indicates parameters for an integer DRX cycle;
determine whether the one or more DRX configurations include a second DRX configuration that indicates parameters for a non-integer DRX cycle;
determine whether to apply the parameters for the integer DRX cycle or the parameters for the non-integer DRX cycle based one whether the one or more DRX configurations include the second DRX configuration or not;
start, based on the parameters for the integer DRX cycle, a DRX timer in a case that the one or more DRX configurations do not include the second DRX configuration; and
start, based on the parameters for the non-integer DRX cycle, the DRX timer in a case that the one or more DRX configurations include the second DRX configuration.

21. The UE of claim 20, wherein:
the parameters for the non-integer DRX cycle are associated with a frame per second (FPS) of data traffic that is received by the UE, and
the parameters for the non-integer DRX cycle are indicated by decimal forms or fractional forms.

22. The UE of claim 20, wherein the second DRX configuration is configured for a DRX group.

23. The UE of claim 20, wherein:
the one or more DRX configurations include a third DRX configuration, and
the third DRX configuration indicates parameters for a second non-integer DRX cycle.
